(19) United States
(12) Patent Application Publication
(10) Pub. No.: US 2016/0310947 A1
(43) Pub. Date: Oct. 27, 2016

(54) CONTROLLING FLUID MICRO-COMPARTMENTS

(71) Applicant: ISIS INNOVATION LIMITED, OXFORD (GB)

(72) Inventor: Edmund WALSH, Oxford (GB)

(21) Appl. No.: 15/101,914

(22) PCT Filed: Dec. 4, 2014
(86) PCT No.: PCT/GB2014/053614

§ 371 Date: Jun. 5, 2016

(30) Foreign Application Priority Data
Dec. 4, 2013 (GB) 1321433.3

(51) Int. Cl. B01L 3/00; G01N 1/38

(52) U.S. Cl. CPC B01L 3/502784; G01N 1/38; B01L 2200/0673; B01L 2200/16; B01L 2200/0668; B01L 2400/0421; B01L 2300/0867; B01L 2300/0877; B01L 2400/043; B01L 2200/10; B01L 2400/0478; B01L 2300/0832

(57) ABSTRACT

A method of controlling interactions between fluid compartments in a fluid flow, comprising providing a first phase within a fluid conduit; enclosing within the first phase a separating compartment of a second phase that is immiscible with the first phase; providing at least one reagent compartment of a third phase that is immiscible with the second phase; and arranging the compartments such that at least one of the separating compartment and the at least one reagent compartment has a length equal to or greater than the conduit diameter.

The present invention relates to a method of controlling interactions between fluid compartments in a fluid flow. The present invention further relates to a method of generating a three-dimensional structure of vesicles or immiscible compartments. The present invention further relates to a method of controlling interactions between portions of a fluid in flow.

### Multi-Phase Systems

According to one aspect of the invention, there is provided a method of controlling interactions between fluid compartments in a fluid flow, comprising: providing a first phase within a fluid conduit; enclosing within the first phase a separating compartment of a second phase that is immiscible with the first phase; providing at least one reagent compartment of a third phase that is immiscible with the second phase; and arranging the compartments such that at least one of the separating compartment or the at least one reagent compartment has a length that is equal to or greater than the fluid conduit diameter.

According to another aspect of the invention, there is provided a method of controlling interactions between fluid compartments in a fluid flow, comprising: providing a first phase within a fluid conduit; enclosing within the first phase a separating compartment of a second phase that is immiscible with the first phase; providing at least one reagent compartment of a third phase that is immiscible with the second phase; and arranging the compartments such that at least one of the separating compartment and the at least one reagent compartment has a length that is equal to or greater than the conduit diameter.

Preferably, there are at least two reagent compartments. Preferably, the method further comprises arranging the compartments such that a thin film of the first phase is formed between the fluid conduit and both the separating compartment and the at least one reagent compartment.

Preferably, the method further comprises arranging the compartments such that a thin film of the second phase is formed between the at least one reagent compartment and the first phase.

Preferably, the method further comprises arranging the compartments such that the separating compartment and the at least one reagent compartment have different speeds of travel in the fluid flow. Preferably, the method further comprises arranging the compartments with predetermined spacings relative to one another in the direction of flow in the fluid conduit such that after a predetermined period of flow of the compartments the separating compartment confines the at least one reagent compartment to travel at the same speed in the flow. Preferably, the method further comprises arranging the compartments such that after a further predetermined period of flow of the compartments a further reagent compartment catches up with the confined reagent compartment due to travel at different speeds in the flow and interacts with the confined reagent compartment.

By arranging the compartments with predetermined spacings as recited above, migration and interaction of the compartments (also referred to herein as ‘droplets’) can be controlled, and in particular migration and interaction of the different reagent compartments e.g. mixing or being in contact for diffusion. One or more thin films may be formed between the fluid conduit and the reagent compartment.

As referred to herein, a ‘compartment’ may comprise a solid, a fluid or a combination of both a solid and a fluid. For example, a compartment (comprising a fluid) may be solidified within the fluid conduit, such as hydrogels/agarose solutions by temperature/UV control, for example, for the encapsulation of other media, such as cells, particles, DNA, etc. Thus, a compartment may be a fluid, a solid, contain solid particles, and/or may be turned from a liquid to a solid (and vice versa). In this context ‘confines’ preferably means causing the reagent compartment to travel at the same speed in the flow as the separating compartment. As used herein the term ‘thin film’ includes any form of film, of whatever thickness, but in particular a film sufficiently thin that a surface or interface affects the behaviour of the fluid; typically the thickness would be from micrometres to millimetres; preferably, a film is considered thin if it is less than 20% of the channel diameter (i.e. film thickness divided by tube radius 0.2). As used herein the term ‘immiscible’ preferably means fluids that separate over time if initially mixed and/or fluids that when placed in contact with each other do not substantially diffuse into each other. Reagent compartments may be miscible with one another, as they are of the same phase. A fluid conduit may for example be a channel, preferably a micro channel, a capillary or a tube, or a capillary/tube within a larger capillary/tube. As used herein, the term ‘phase’ preferably means a substance (whether a liquid, solid or gas) that is distinct from another substance, rather than a specific phase of a substance (e.g. liquid or gas). For example, herein, a fluorocarbon and water may be described as different phases. However, liquids and solids may also be referred to as (different) phases, in the appropriate context. As referred to herein, the term “fluid” preferably means a liquid and/or gas.

Preferably each of the reagent compartments has different compositions. Preferably, each of the reagent compartments may have different temperatures. Preferably each reagent compartment comprises a reagent. Preferably, the reagent compartments have properties such that when the reagent compartments are in contact with one another they merge and mixing of the reagent compartments occurs.

Alternatively, the reagent compartments may have properties such that when reagent compartments are contact with one another they do not merge and diffusion between the reagent compartments occurs. This can enable controlled diffusion between the different reagent compartments. Preferably at least one reagent compartment further comprises means for preventing merging. Preferably the means for preventing merging comprises a surfactant and preferably a lipid bilayer.

The method may further comprise selecting the properties of the separation compartment such that it moves in the fluid conduit slower than the reagent compartment(s) and arranging the separating compartment downstream of the reagent compartments. The method may further comprise selecting the properties of the or a further separating compartment such that it moves in the fluid conduit faster than the reagent compartments and arranging the or the further separating compartment upstream of the different reagent compartments.

The method may further comprise arranging the reagent compartments such that the first phase directly encloses the reagent compartments. The method may further comprise arranging the reagent compartments such that the separating compartment directly encloses the reagent compartments. If a reagent compartment is engulfed by a separating compartment, the reagent compartment will travel faster than the separating compartment, at least until such time as it reaches the interface between the separating compartment and the first phase, at which point its travel is ‘confined’ to the same speed as the separating compartment.

Preferably, the method further comprises selecting the properties of the three phases so that the surface tensions between the three phases are such that on contact between them the first phase encloses the second phase and the second phase encloses the third phase. Preferably, the length of the reagent compartment(s) (preferably individually and/or when enclosed) is equal to or greater than the conduit diameter. Preferably, the length of the separating compartment(s) is equal to or greater than the conduit diameter. The enclosing may occur spontaneously.

### Four Phase

The method may further comprise providing at least two separating compartments, enclosing within the first phase a super-separating compartment of a fourth phase that is immiscible with both the first phase and the second phase, and arranging the compartments with predetermined spacings relative to one another in direction of flow in the fluid conduit such that after a predetermined period of flow of the compartments the super-separating compartment confines at least one of the separating compartments.

### Indexing

The method may further comprise arranging within the separating compartment an indexing compartment of a further phase that is immiscible with the second phase, and preferably immiscible with the third phase, and selecting the properties of the second, third and further phases so that the surface tensions between the three phases are such that on contact between them the second phase encloses the further phase, and the third phase and the further phase do not enclose one another.

Preferably, one or more indexing compartments are arranged between reagent compartments such that merging of reagent compartments is prevented. Each separating compartment may comprise an indexing compartment that has specific identifying properties for that separating compartment. The specific identifying properties are preferably compartment volume, compartment composition, or number of sub-compartments.

### Flow Reversal

The method may further comprise flowing the compartments and then reversing the flow direction such that reagent compartments not confined by the separating compartment return to the arrangement with the predetermined spacings, or preferably to a predetermined spaced arrangement. The method may further comprise flowing the compartments in a flow direction and then reversing the flow direction such that a portion of the separating compartment breaks away.

Preferably the method further comprises aspiration of the different phases into a channel in a predetermined sequence to create the compartments with the predetermined spacings. Preferably the channel has only one inlet for aspiration. Preferably, the length of a compartment and/or the spacings between compartments in the fluid conduit can be determined by the duration for which a phase is aspirated.

As referred to herein, aspiration of a fluid into a channel or fluid conduit preferably means aspiration of a liquid and/or a gas—both of which are commonly understood to be fluids.

Preferably, magnetic particles may be used to transport media within and/or between reagent compartments during fluid flow, wherein the magnetic particles may be held in a fixed position by a magnetic field while the reagent compartments flow past. Preferably, the method further comprises using magnetic particles to transport media within and/or between reagent compartments during fluid flow, wherein a magnetic field may be used to move the magnetic particles within and/or between reagent compartments.

Preferably, the method further comprises transporting the magnetic particles between reagent compartments through the separating compartment. Preferably, the method further comprises transporting the magnetic particles between reagent compartments through the first phase. Preferably, the method further comprises transporting the magnetic particles between reagent compartments via a thin film that fluidly connects the reagent compartments.

According to another aspect of the invention, there is provided a method of creating a multiphase system comprising engulfing one or more separate fluid compartments by a second fluid, and engulfing that second fluid by a third fluid (optionally engulfing that third fluid by one or more further fluids) within a channel using interfacial tension between fluids to create such flow systems. Preferably the system is created in a channel with only one inlet. Preferably the length of individual compartments in the flow direction is equal to or greater than the channel diameter.

According to a further aspect of the invention, there is provided a method of controlling interactions between fluid compartments comprising selecting the properties (in particular the interfacial tensions) of three phase fluid compartments, so as to control interaction (and in particular relative speed of travel in a pressure driven flow) of the compartments.

### 3-D Structure

According to a yet further aspect of the invention, there is provided a method of generating a three-dimensional structure of vesicles or immiscible compartments comprising: generating an interface between two immiscible phases in a vessel; and dispensing vesicles or immiscible compartments relative to the interface in order to dispense vesicles or immiscible compartments onto the interface.

Preferably, the method further comprises changing the properties of the two immiscible phases such that the vesicles or immiscible compartments transfer through the interface to the other phase.

Preferably, the method further comprises positioning a channel outlet for dispensing vesicles or immiscible compartments. Preferably the immiscible compartments are immiscible with either of the immiscible phases in the vessel. Preferably the vesicles or compartments are produced by any of the methods described herein.

### Emulsification

Preferably, the method further comprises selecting the properties of the second phase and/or the third phase such that at a predetermined flow rate instabilities occur at an interface between the second phase and the third phase causing small emulsion compartments of the reagent compartment to be shed into the separating compartment.

Preferably, the method further comprises adding a surfactant to the separating compartment such that the interfacial tension is lowered between the second phase and the third phase.

Preferably the method further comprises arranging the compartments initially with predetermined spacings relative to one another in the direction of the fluid flow in the fluid conduit such that after a predetermined period of flow of the compartments the separating compartment comes into contact with the reagent compartment.

Preferably the method further comprises providing within the first phase in the fluid conduit a further compartment of a further phase that is immiscible with the first phase and second phase, arranging the further compartment downstream of the reagent compartment, and selecting the properties of the further compartment such that it travels in the fluid flow slower than the reagent compartment.

Preferably the method further comprises arranging the further phase to wet the walls of the fluid conduit.

According to a yet further aspect of the invention, there is provided apparatus for controlling interactions between fluid compartments in a fluid flow, comprising means for providing a first phase within a fluid conduit; means for enclosing within the first phase a separating compartment of a second phase that is immiscible with the first phase; means for providing at least one reagent compartment of a third phase that is immiscible with the second phase; and means for arranging the compartments such that the length of the separating compartment is equal to or greater than the conduit diameter.

According to yet another aspect of the invention, there is provided apparatus for controlling interactions between fluid compartments in a fluid flow, comprising means for providing a first phase within a fluid conduit; means for enclosing within the first phase a separating compartment of a second phase that is immiscible with the first phase; means for providing at least one reagent compartment of a third phase that is immiscible with the second phase; and means for arranging the compartments such that at least one of the separating compartment and the at least one reagent compartment has a length equal to or greater than the fluid conduit diameter.

Preferably, the apparatus comprises a fluid conduit. Preferably, the apparatus further comprises means for arranging the compartments such that a thin film of the first phase is formed between the fluid conduit and both the separating compartment and the at least one reagent compartment.

Preferably, the apparatus further comprises means for arranging the compartments such that a further thin film of the separating phase is formed between the reagent and separating phase, and such that the separating compartment and the reagent compartments have different speeds of travel in the fluid flow. Preferably, the apparatus further comprises means for arranging the compartments with predetermined spacings relative to one another in the direction of flow in the fluid conduit such that after a predetermined period of flow of the compartments the separating compartment confines at least one of the reagent compartments to travel at the same speed in the flow. Preferably, the apparatus further comprises means for arranging the compartments such that after a further predetermined period of flow of the compartments a further of the reagent compartments catches up with the confined reagent compartment due to travel at different speeds in the flow and interacts with the confined reagent compartment.

Preferably, the apparatus further comprises means for selecting the properties of the second phase and/or the third phase such that at a predetermined flow rate instabilities occur at an interface between the second phase and the third phase causing small emulsion compartments of the reagent compartment to be shed into the separating compartment.

Preferably, the apparatus further comprises means for adding a surfactant to the first fluid compartment such that the interfacial tension is lowered between the second phase and the third phase.

According to a yet further aspect of the invention, there is provided apparatus for generating a three-dimensional structure of vesicles or immiscible compartments comprising: means for generating an interface between two immiscible phases in a vessel; and means for dispensing vesicles or immiscible compartments relative to the interface in order to dispense vesicles or immiscible compartments onto the interface.

Preferably, the apparatus further comprises means for changing the properties of the two immiscible phases such that the vesicles or immiscible compartments transfer through the interface to the other phase. Preferably, the vesicles or compartments may be produced using any of the apparatus described herein.

### Mass Transfer

According to a yet further aspect of the invention, there is provided a method of controlling interactions between portions of a fluid in flow comprising providing the fluid having a first phase within a fluid conduit; enclosing within the first phase a separating compartment of a second phase that is immiscible with the first phase; arranging the first phase such that it has different properties downstream and upstream of the separating compartment.

Preferably, the method further comprises arranging the separating compartment such that the length of the separating compartment is equal to or greater than the fluid conduit diameter.

Preferably, selecting the properties of the separating compartment such that a thin film of a predetermined thickness of the first phase is formed between the fluid conduit and the separating compartment such that exchange between downstream and upstream of the separating compartment occurs at a predetermined rate.

Preferably, the method further comprises flowing the phases to support the exchange.

Preferably the different properties are different composition. Alternatively, the different properties may be different temperatures. Preferably the downstream composition comprises a mixture of differently sized components such that selective exchange of the components between downstream and upstream of the separating compartment depends on the thickness of the thin film.

### Cell Culture

The downstream composition may comprise a substrate and the upstream composition may comprise a component consuming the substrate. The substrate may be a reagent and the component consuming the reagent may be reacting with the reagent.

The rate of exchange of the substrate between downstream and upstream of the separating compartment preferably matches the rate of substrate consumption by the consuming component upstream of the separating compartment.

Preferably the consuming component is a biological organism. Alternatively, the consuming component may be a reagent or a catalyst.

### Sizing

The downstream composition may comprise a mixture of differently sized components and the thin film is such that selective exchange depending on size occurs. The downstream composition may comprise a mixture and the upstream composition comprises an environment that is selectively compatible with selective components of the mixture.

### Three Phase

Preferably the method further comprises providing within the fluid conduit a further phase that is immiscible with the first phase and arranging the further phase such that it directly encloses the first phase.

The method may further comprise enclosing within the first phase a further separating compartment of the second phase or a third phase that is also immiscible with the first phase; arranging the further separating compartment upstream of said separating compartment; and selecting the properties of the further separating compartment such that a thin film of a predetermined thickness of the first phase is formed between the fluid conduit and the further separating compartment such that exchange between upstream and downstream of the further separating compartment occurs at a predetermined rate.

Preferably, the method further comprises selecting the properties of the or a further separation compartment such that it moves in the fluid conduit faster than the reagent compartments and the or the further separating compartment are arranged upstream of the different reagent compartments.

### Electrophoresis; Magnetic Immobilisation

Preferably, the method further comprises providing an electric voltage between a first portion of the first phase upstream of the separating compartment and a first portion of the first phase downstream of the separating compartment for electrophoresis.

The method may further comprise fixing a substrate to the fluid conduit. Preferably the fixing comprises immobilising one or more magnetic particles by means of a magnetic field.

Magnetic particles may be used to transport media within and/or between reagent compartments during fluid flow, wherein the magnetic particles are held in a fixed position by a magnetic field while the reagent compartments flow past. Magnetic particles may also be used to transport media within and/or between reagent compartments during fluid flow, wherein a magnetic field is used to move the magnetic particles within and/or between reagent compartments.

Preferably, the second and/or third phase may comprise a fluid and/or a solid. Preferably, the method may further comprise solidifying (at least partially) a liquid contained in a compartment within the fluid conduit. Preferably, the apparatus may further comprise means for solidifying (at least partially) a liquid contained in a compartment within the fluid conduit.

The methods described herein have numerous applications, for example:
use in mass spectrometry sample preparation
polymerase chain reaction (PCR) (e.g. for amplification of DNA)
drug screening, creation and/or delivery
cell culturing
creating bilayers (e.g. cell membranes)
crystallisation (e.g. protein)
creating concentration ingredients (e.g. chemotaxis)
creating artificial tissue materials, genes and/or proteins

According to a yet further aspect of the invention, there is provided apparatus for controlling interactions between portions of a fluid in flow comprising means for providing a fluid having a first phase within a fluid conduit; means for enclosing within the first phase a separating compartment of a second phase that is immiscible with the first phase; means for arranging the first phase such that it has different properties downstream and upstream of the separating compartment.

Preferably, the apparatus further comprises means for arranging the separating compartment such that the length of the separating compartment is equal to or greater than the fluid conduit diameter.

Preferably, the apparatus further comprises means for selecting the properties of the separating compartment such that a thin film of a predetermined thickness of the first phase is formed between the fluid conduit and the separating compartment such that exchange between downstream and upstream of the separating compartment occurs at a predetermined rate.

The invention extends to methods and/or apparatus substantially as herein described with reference to the accompanying drawings.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The invention also provides a signal embodying a computer program for carrying out any of the methods described herein and/or for embodying any of the apparatus features described herein, a method of transmitting such a signal, and a computer product having an operating system which supports a computer program for carrying out any of the methods described herein and/or for embodying any of the apparatus features described herein.

Any apparatus feature as described herein may also be provided as a method or use feature, and vice versa. As used herein, means plus function features may be expressed alternatively in terms of their corresponding structure, such as a suitably programmed processor and associated memory.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

Furthermore, features implemented in hardware may generally be implemented in software, and vice versa. Any reference to software and hardware features herein should be construed accordingly.

These and other aspects of the present invention will become apparent from the following exemplary embodiments that are described with reference to the following figures in which:

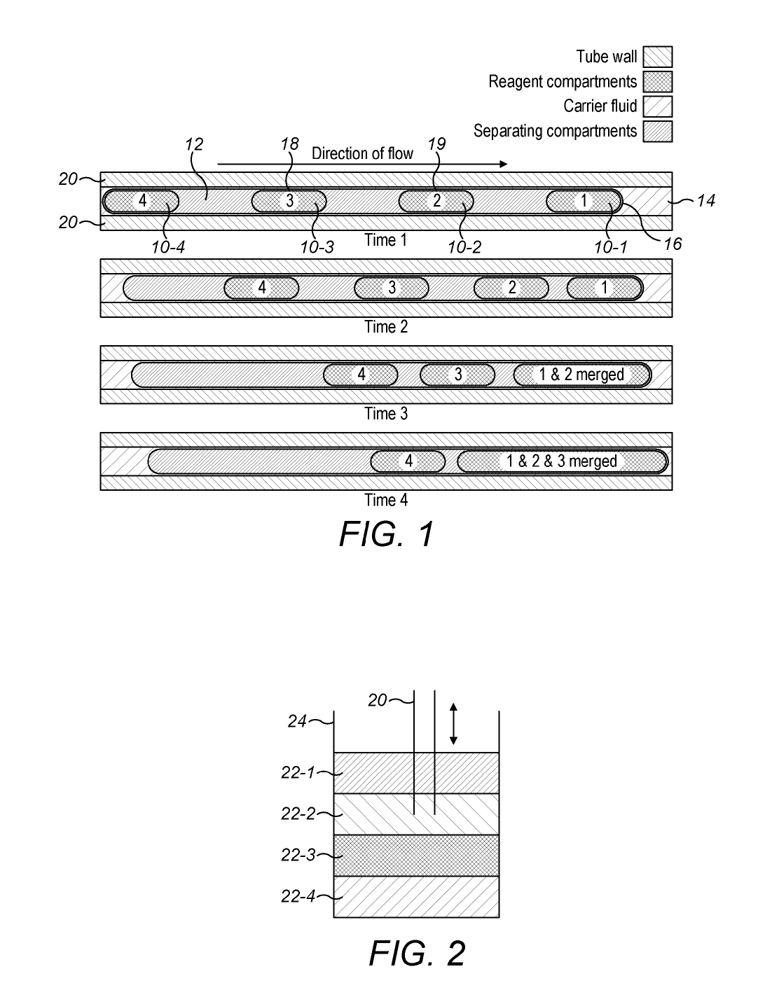

FIG. 1 shows an example of a three phase system in a channel;

FIG. 2 shows aspiration of different fluids from a reservoir that contains different immiscible phases;

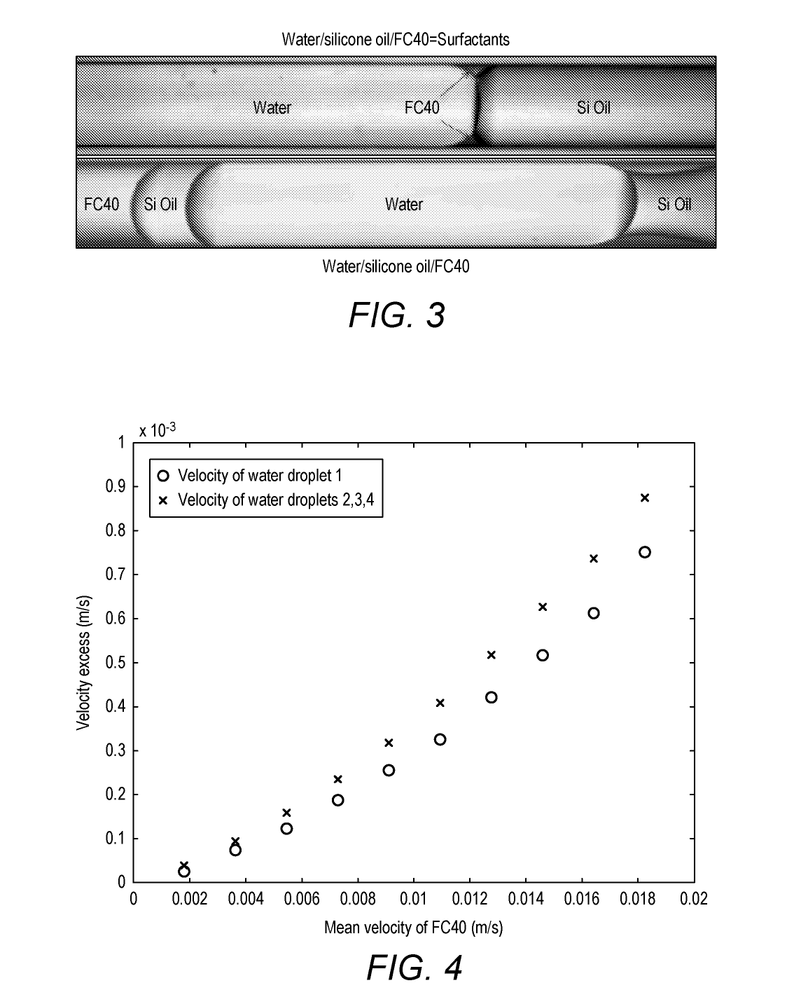

FIG. 3 shows micrographs of three immiscible fluid phases in a channel;

FIG. 4 shows a graph of velocities of compartments under varying flow conditions;

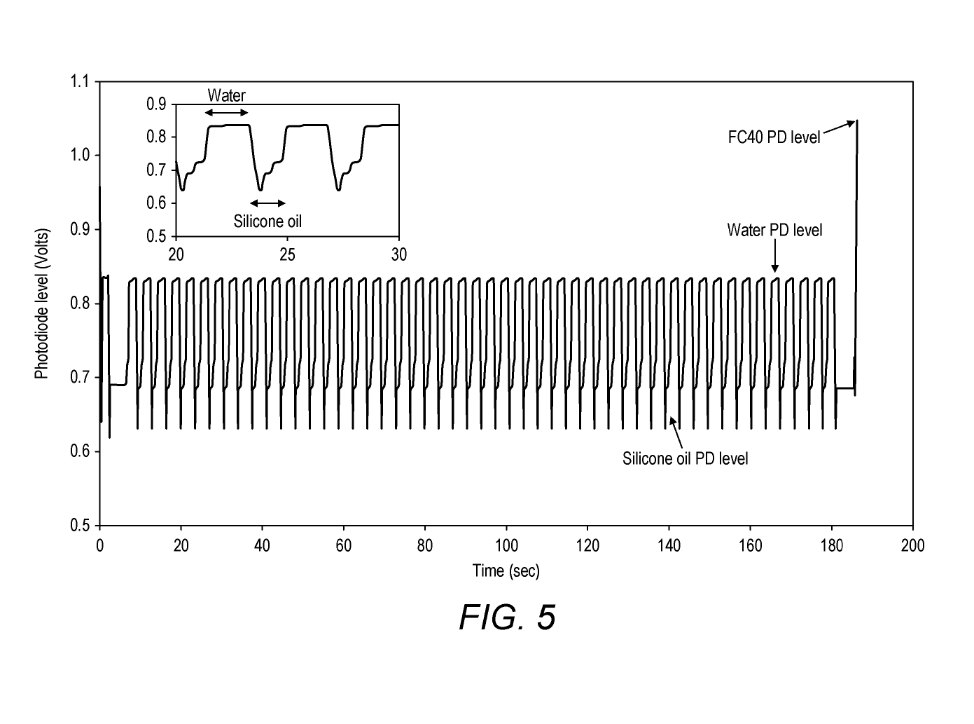

FIG. 5 shows detection data of a separating compartment with 50 reagent compartments;

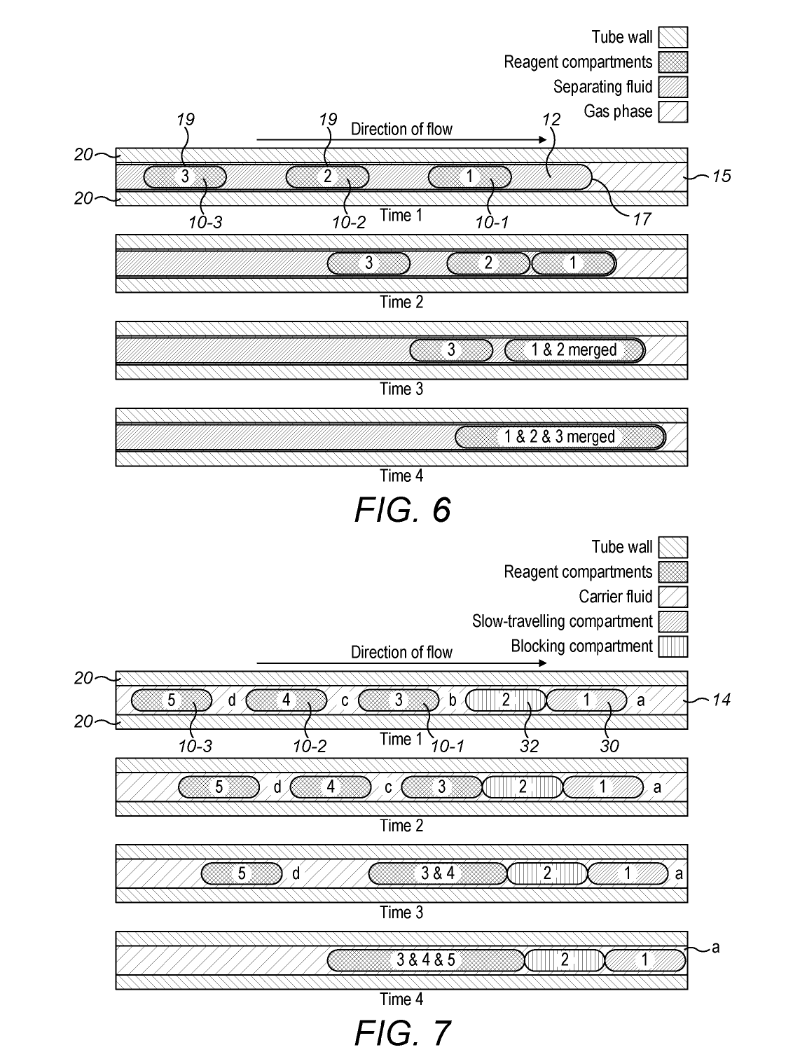

FIG. 6 shows an example of a three phase system with one of the phases being a gas phase;

FIG. 7 shows an example of a three phase system including a blocking compartment;

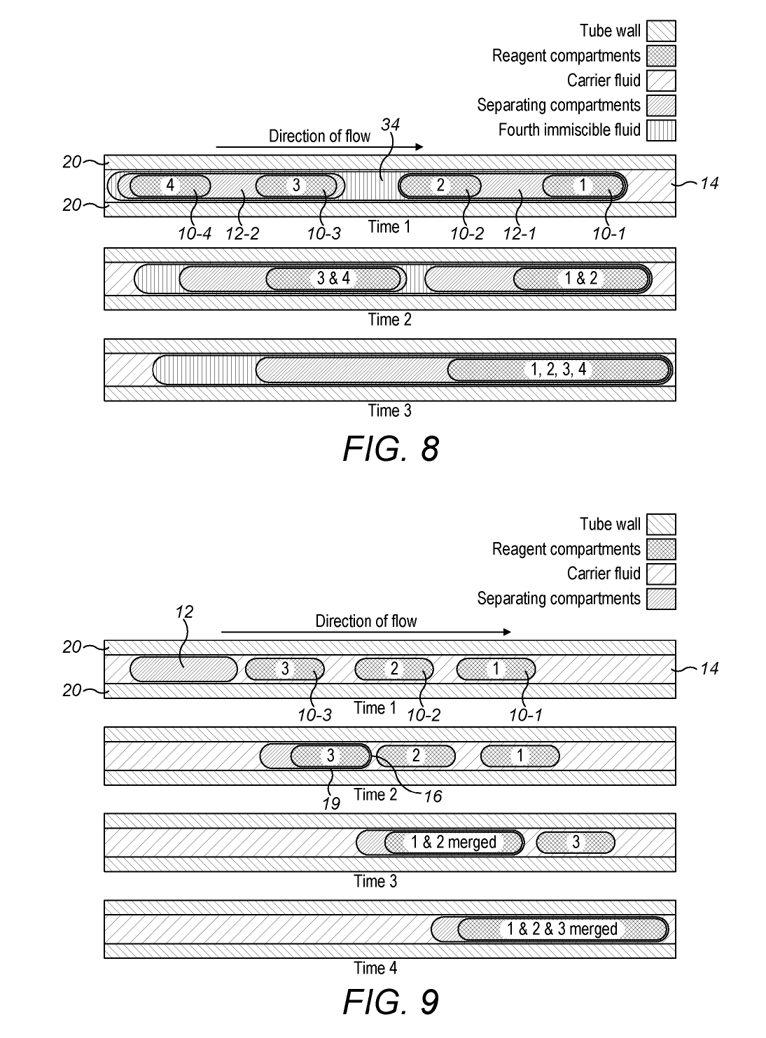

FIG. 8 shows an example of a three phase system with a further fourth phase;

FIG. 9 shows a further example of a three phase system;

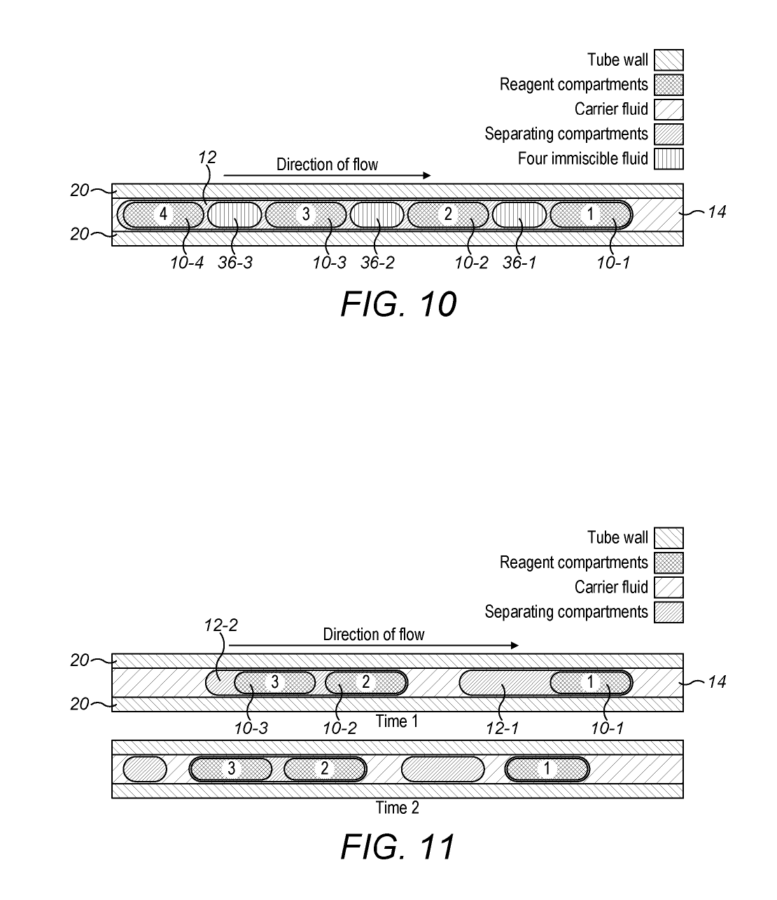

FIG. 10 shows another example of a three phase system with a further fourth phase;

FIG. 11 shows an example of a three phase system with a portion of one of the phases detaching;

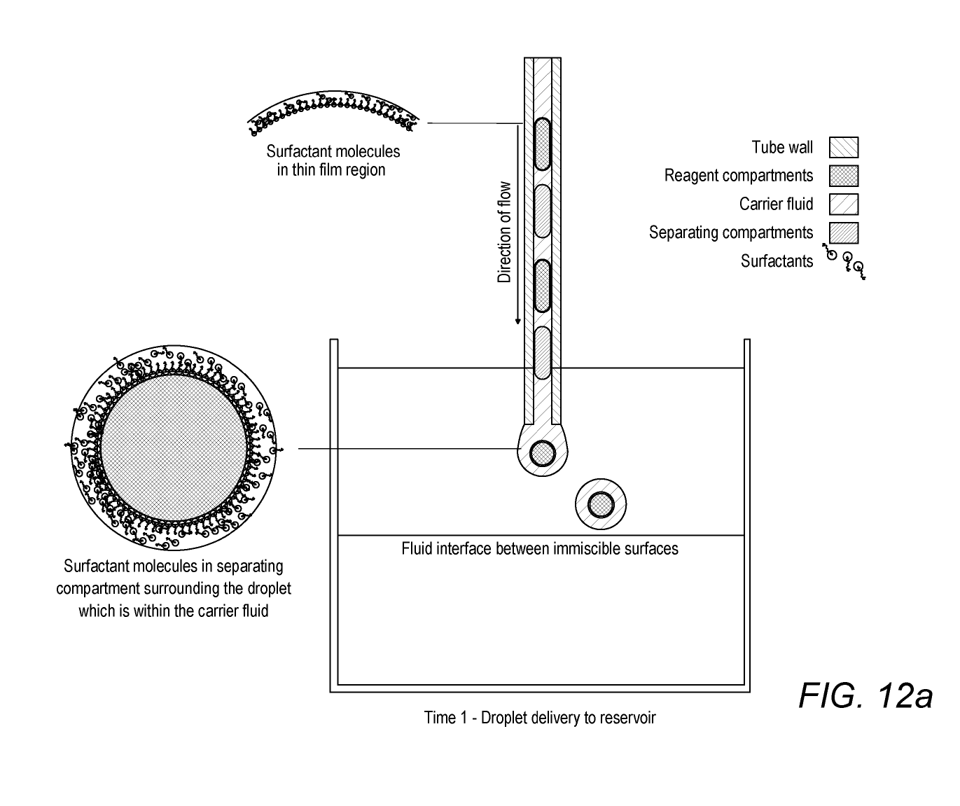

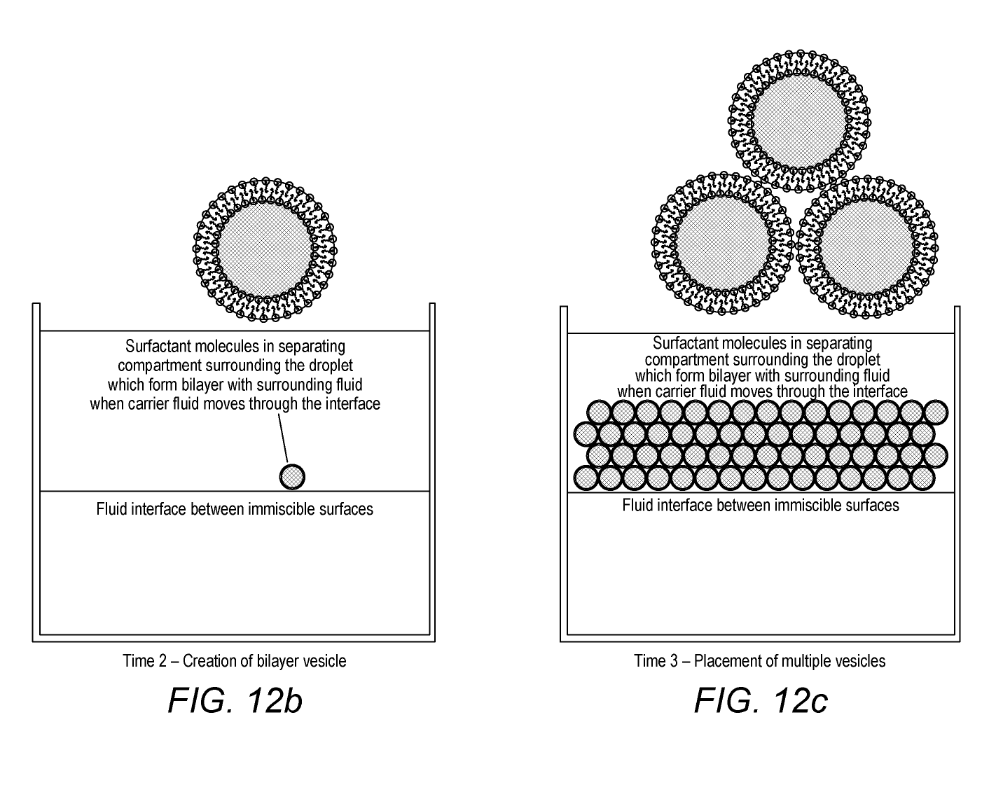

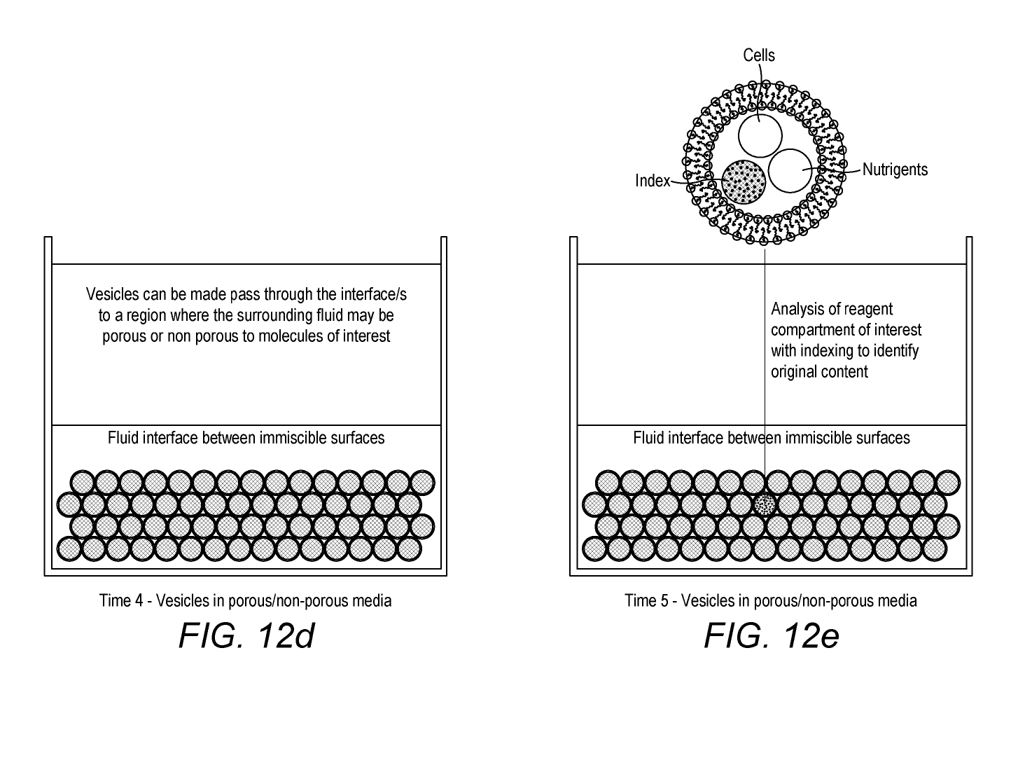

FIGS. 12a-e show an example of building a network of reagent compartments;

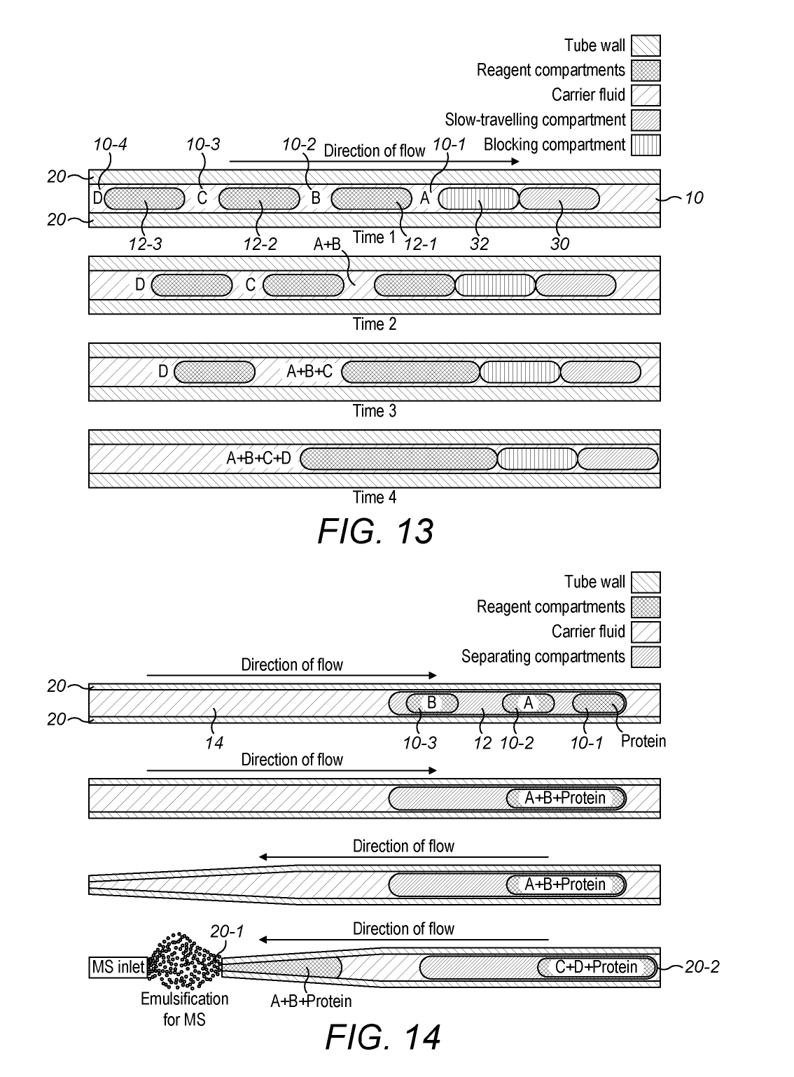

FIG. 13 shows another example of a three phase system including a blocking compartment;

FIG. 14 shows an example of a multi-phase system for providing samples for mass spectrometry;

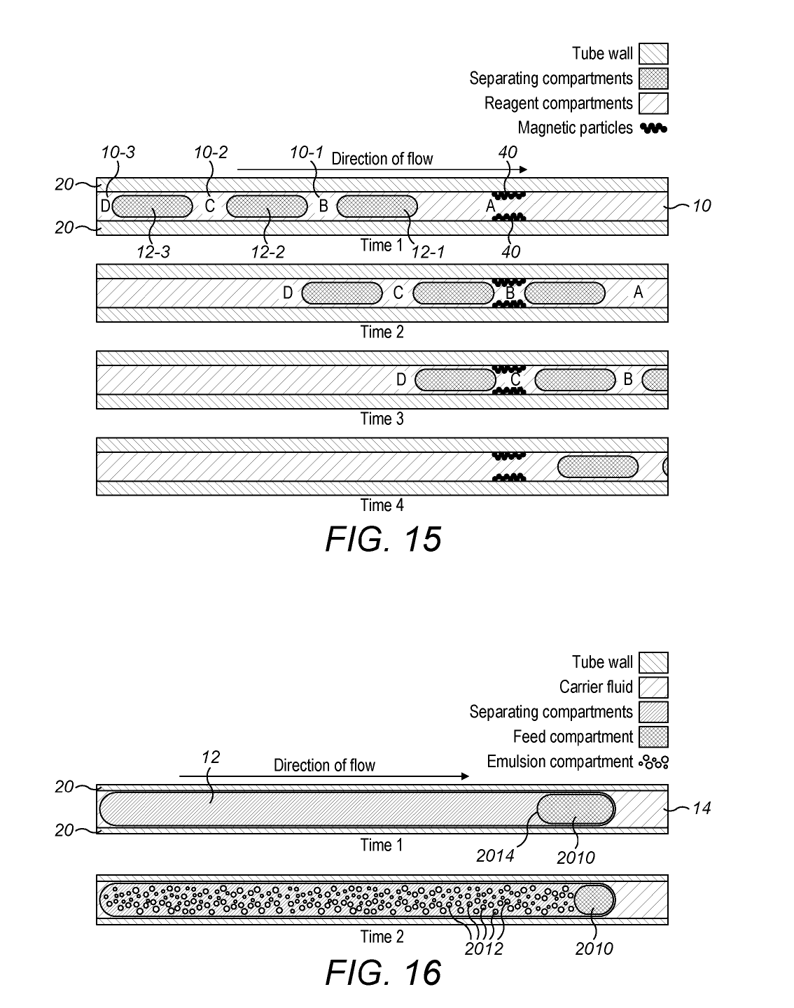

FIG. 15 shows an example of a multi-phase system for exposing a substrate to a series of reagents;

FIG. 16 shows an example of a multi-phase system for generating an emulsion;

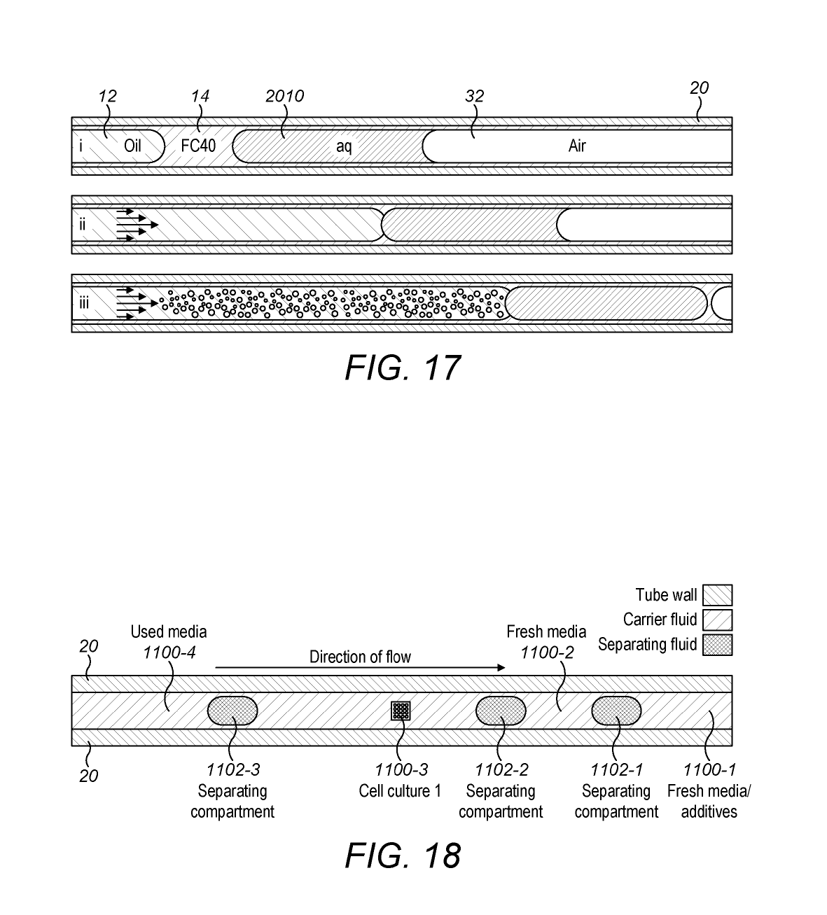

FIG. 17 shows a further example of a multi-phase system for generating an emulsion;

FIG. 18 shows an example of a two phase system for controlled mass transfer;

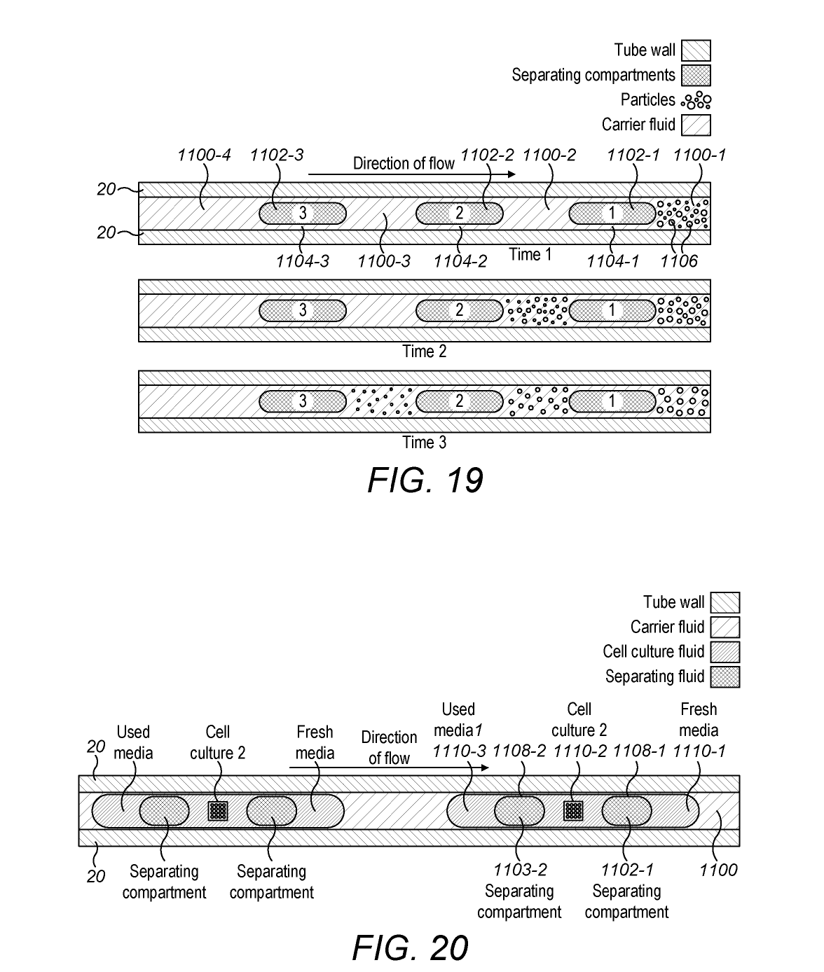

FIG. 19 shows an example of a two phase system for particle sizing;

FIG. 20 shows an example of a three phase system for controlled mass transfer;

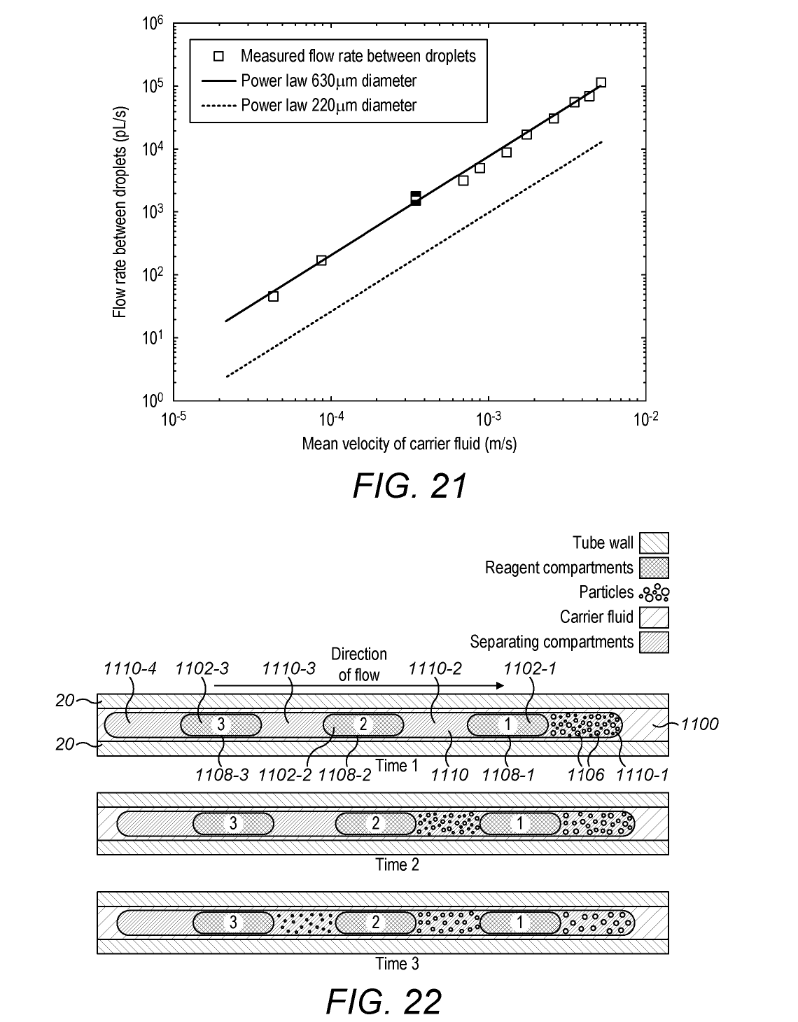

FIG. 21 shows a graph of flow rates between individual portions of the reagent compartment in a three phase system for controlled mass transfer under varying flow conditions;

FIG. 22 shows an example of a three phase system for particle sizing;

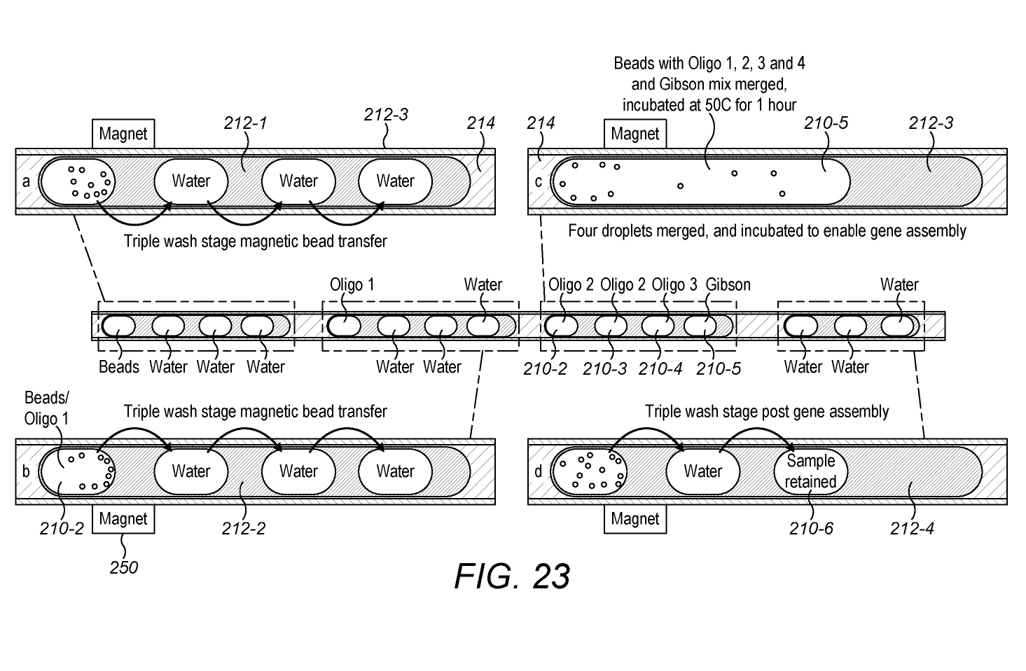

FIG. 23 shows an example of moving magnetic particles using a magnetic field;

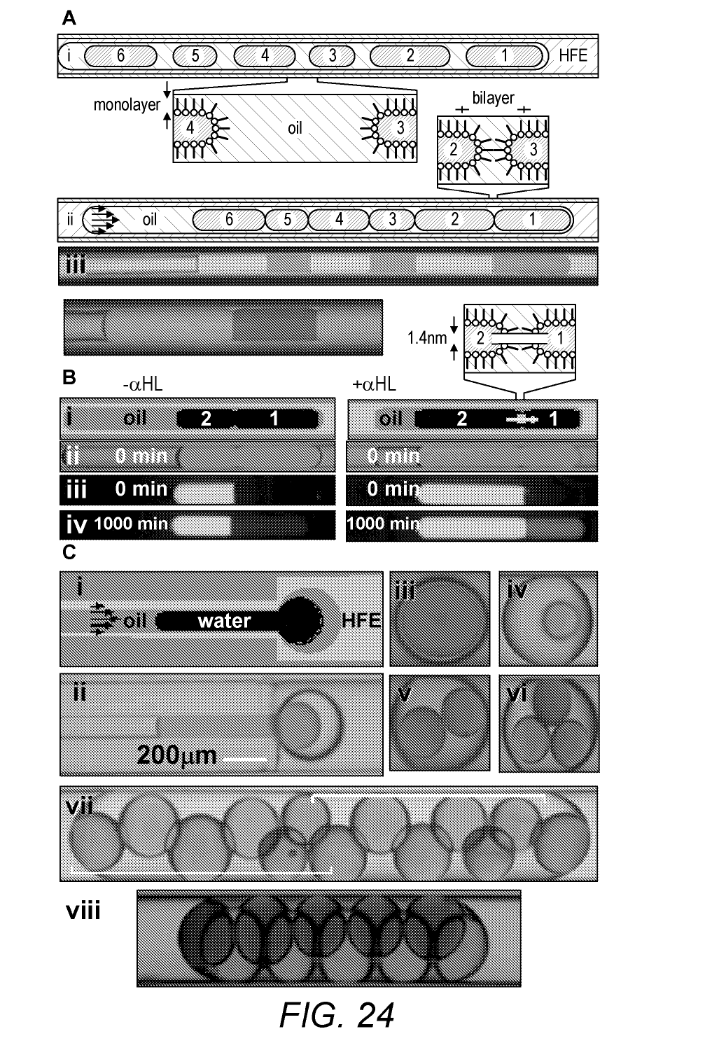

FIG. 24 shows an exemplary embodiment of aqueous compartments separated by lipid bilayers; and

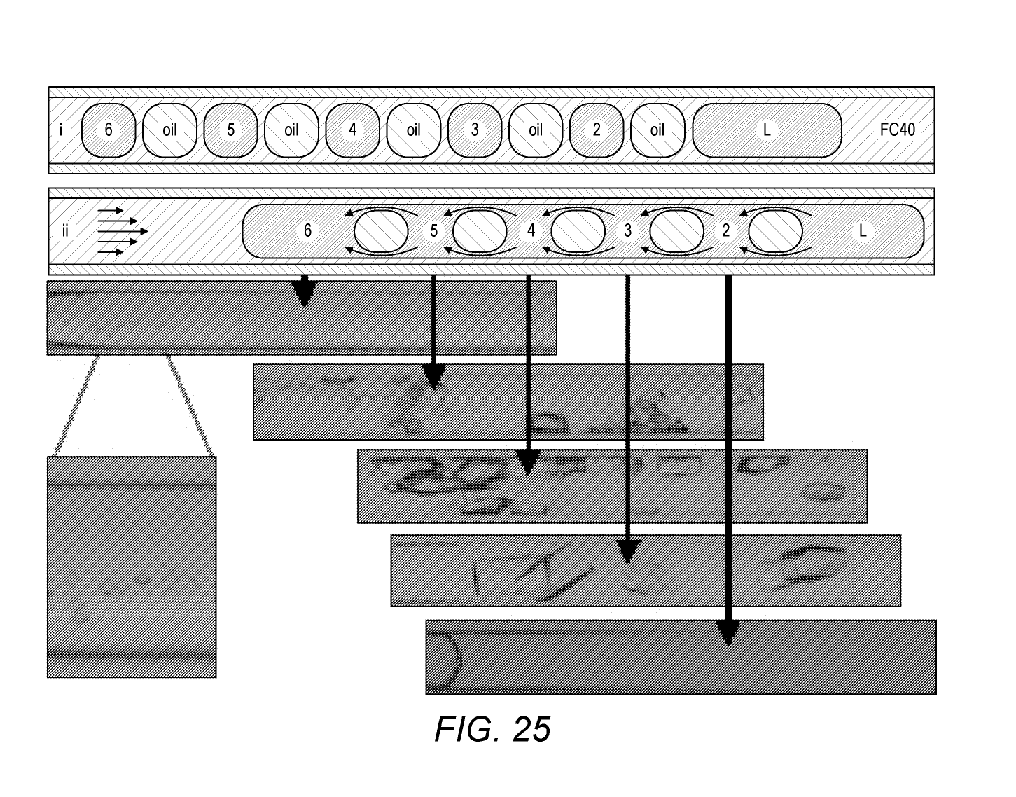

FIG. 25 shows an exemplary embodiment of screening crystallisation conditions.

Many bio/chemical reactions require several different constituents to be mixed prior to the reactions taking place, sometimes in a specific order, such as the Polymerase Chain Reaction for amplification of DNA. In addition there is often the need for multistep reactions that require a series of reactions to occur in a specific sequence, and at specific times, to achieve the required final product. A substance or compound that is added to a system in order to bring about a chemical reaction, or added to see if a reaction occurs, is often referred to as a ‘reagent’.

Currently employed technologies typically achieve such reactions by pipetting the required molecules at the required times, which can be labour intensive and prone to human error. Further application where control of exposure to reagents is crucial include probing cell-cell interaction, probing multi-cellular interactions, screening toxicity, materials development, microbiology, biological analysis, DNA studies etc. Controlled diffusion of different constituents in close contact with each other is another requirement for certain assays, for example for protein crystallisation or for cell-cell interactions.

A compartment (or ‘droplet’) containing a reagent may be referred to as a ‘reagent compartment’ (sometimes also referred to as a ‘sample’). In microfluidics, reagent compartments typically have for example picolitre (ph to microlitre (ml) volumes.

State of the art microfluidics allows controlled mixing/reactions on chips by bringing several different mixtures together at the required time, commonly referred to as a “lab on a chip” device or system. However, control of such systems is difficult to achieve due to the need for external sources to cause the coalescence of different reagent compartments, e.g. lasers, electrodes or complex channel networks of varying geometries that must be timed accurately to allow the coalescence at the required times. In such microfluidics networks many external sources are required for reaction timing and long start up times are often required to achieve a steady state operation.

Typically each lab on a chip design is for a specific experiment and there is little flexibility for using different reagents, number of samples, cells, number of reagent compartment merging events, reagent compartment spacing etc. Therefore each experiment requires the design of a new lab on a chip which is both time consuming and costly.

In known microfluidic mixing/reactions on chip it is typically a requirement to have surfactants as part of the chemical reaction to control the coalescence, although such surfactants can negatively impact the efficiency/accuracy and purity of the results. Uncontrolled coalescence can occur between sequential reagent compartments and render the results of any experiments/synthesis invalid, and the number of independent reaction steps that can take place is limited by micro-channel complexity, available size and excessive requirements for control.

In addition current lab on chip technologies are typically limited to several material choices with polydimethylsiloxane (PDMS), poly(methyl methacrylate) (PMMA) and polycarbonates (PC) being the most common, which also limits the fluids/materials that can be used within them. Chemical reactions can require aggressive fluids, which may not be compatible with usual microfluidic chip materials. For example PDMS is a commonly employed material despite having well-documented swelling issues with commonly used fluids.

Hence there is a need for a microfluidic technology that allows the controlled exposure to, and merging of, different solutions for control of the interaction of constituent parts.

The limitations of existing laboratory and lab on a chip based technologies can be overcome with a simpler, more efficient methodology of mixing reagent compartments in a controlled manner in a single channel with high resolution on both spatial and temporal parameters in a passive way. Also, the spacing between reagent compartments can be controlled for optimum heat and mass transport properties between walls or sequential samples, which has applications in heat and mass transfer areas of engineering science, for example. Thus, fluid physics in microfluidics are used to achieve mixing, separation and mass transfer, as opposed to geometry-based mixing as conventionally known in microfluidics.

In addition several external processes may take place such as heating/cooling, mixing, mass transfer etc. Gravity can be used as the pumping mechanism and thereby external pumps and electrical sources are unnecessary. Microfluidic multi-channel systems can be used. Alternatively external pumps (such as a syringe pump) can be used, to allow controlled mixing/reactions of reagents. Single or multistep reactions can be performed. The use of surfactants is optional.

The ability to manipulate micro- to femto-litre volumes has many practical applications, but current microfluidic devices are usually complex and/or dedicated to one purpose. Thus, the invention provides a simple solution that can be used by any experimental laboratory—a fluid conduit (such as a Teflon® tube) attached to a syringe pump. Flow through the tube is driven by gravity or a syringe pump, and interfacial tension and fluid mechanics are exploited to generate and merge any number of drops, and transfer precise volumes between them. More specifically, drops-within-drops are formed within the tube from three or more immiscible phases, and knowledge of tube diameter, interfacial tension, and flow rate is used to control when and where particular drops merge, and components are transferred between them. The invention can be used, for example, to create precisely-defined arrays (emulsions) of aqueous “cells” separated by lipid bilayers, crystallize proteins after serial dilution, ligate and amplify DNA sequences (perform the polymerase chain reaction (PCR)), and screen drugs for effects on human cells.

As will be described in more detail further on, the fluidic architectures described herein are preferably created at the inlet of a fluid conduit (or ‘channel/tube’) by an appropriate dipping between reservoirs and then as the fluidic architecture flows in the conduit the drops come together and merge.

### Multi-Phase Systems

A method for mixing and enabling multi-step reactions controls the relative position of samples in a channel, both spatially and temporally, thus allowing mixing of samples in a controlled way. At least three immiscible phases have different properties such that different fluid compartments travel at different speeds in a pressure-driven flow within a micro channel or capillary. The channel typically has a uniform diameter along its entire length, although a channel with varying diameter may also be used. However, a channel having a uniform diameter has a very simple geometry that is readily available in a range of materials and sizes and can be formed of a bio-compatible tube, for example.

As a first phase (also referred to as the ‘carrier fluid’) moves through the channel it wets the surface of the channel. A second immiscible phase (e.g. a reagent) forms a compartment (or droplet) which flows through the channel without making contact with the solid channel wall. The compartment is typically at least one channel diameter in length. The region of carrier fluid between the channel wall and the second phase compartment is termed the film region.

The film region can prevent contact between the second phase (and for example samples contained in the second phase) and the channel wall. Hence the same channel can be used to process multiple independent samples without possibility of cross contamination, and the same channel can be reused for independent experiments.

The thickness of the film region, also referred to as the film thickness, is determined by the carrier fluid dynamic viscosity (μ), velocity (V), interfacial tension (γ), length, surfactants and the viscosity ratio. The dimensionless capillary number

$$Ca = \frac{μ V}{γ}$$

can provide a measure of the film thickness: the film thickness scales with Ca^{2/3}. Bretherton's lubrication film theory can be used to evaluate the film region.

For the pressure-driven flow the velocity profile in the channel is parabolic (due to the no-slip boundary condition at the channel wall resulting in frictional drag). Compartments with a large film thickness (and consequently lying more centrally in the channel) occupy a faster portion of the channel, and consequently move faster than the average flow. Different compartments with different properties can have different film thicknesses, and therefore move at different relative velocities through a channel.

Selecting properties of the different compartments appropriately can enable the different compartments to move at different velocities in the channel, and hence a first compartment can catch up to a second compartment. The two compartments can then merge, allowing samples to mix.

In an example a system has a fluorocarbon as carrier fluid. Three different water-based compartments are formed in the carrier fluid. Each compartment has approximately the same density, but the interfacial tension is varied between compartments with different surfactant additives (e.g. different concentrations of TWEEN® 20—or other non-ionic surfactant that are particularly suitable for use in aqueous biological fluids) to the compartments. An upstream compartment has a low surfactant concentration and high interfacial tension, and hence forms a relatively thick film region and travels at relatively high speed in the pressure-driven carrier fluid flow. A downstream compartment has a high surfactant concentration and low interfacial tension, and hence forms a relatively thin film region and travels at relatively low speed in the pressure-driven carrier fluid flow. An intermediate compartment located between the upstream and downstream compartments has an intermediate surfactant concentration and intermediate interfacial tension, and hence forms a film region of intermediate thickness and travels at an intermediate speed in the pressure-driven carrier fluid flow.

Due to the difference in travel speeds the upstream compartment catches up with the intermediate compartment, merges and mixes, and then the merged compartment catches up with the downstream compartment, merges and mixes. In this manner, by selecting the compartments' properties, controlled mixing and reaction initiation can be achieved. Provided the initial spacing between the compartments is controlled, as well as the pressure driven flow, the times at which the reagent compartments merge can be controlled, in this example by selection of the interfacial tension of the compartments. The merging occurs passively requiring no external activation. By such controlled merging of compartments the contents of compartments can be varied discretely in time. The duration before compartments merge can be controlled in the range of seconds to days by appropriate selection of parameters. The time and position of a merging event is determined by user-selectable parameters including interfacial tensions, tube diameter, inter-compartment spacing, and flow rate.

External conditions required for chemical and biological reactions, e.g. thermal steps, gas diffusion, fluorescent recording/detection etc. can be applied through the correct choice of immiscible fluids/channel.

In another use of the above-described behaviour a sample or a number of samples (in separate compartments or dissolved in the carrier fluid) are collectively preceded by a first immiscible compartment, and followed by a second immiscible compartment. The first and second immiscible compartments have different viscosity ratios and/or capillary numbers, Ca, such that in a pressure-driven flow the rear immiscible compartment moves at a faster rate than the leading immiscible compartment and hence allow the samples to be brought into contact with each other at a controlled pressure where the force may be controlled by the two immiscible compartments. By thus bringing compartments into contact with one another the contents of compartments can be varied continuously in time. Continuous mixing within flowing reagent compartments would also be an advantage but can be suppressed by the use of surfactants through balancing the Marangoni effect and shear stress forces at the interfaces if desired.

In another use of the above-described behaviour an appropriate surfactant allows formation of a double micelle barrier where reagent compartments come in contact with each other but do not merge together. Instead of merging, the two compartments continue adjacent one another. Controlled diffusion can occur between the compartments across the double micelle barrier, in a similar way to lipid bilayers in real cell environments.

The approach described above requires accurate control of interfacial tension, which may not always be possible. In some situations mixing/reactions/diffusion may not occur in the desired sequence or at the correct rates or times. Another consideration is that for different samples (e.g. different aqueous based samples) the capillary numbers may be close to each other, in which case the relative speeds of travel are small and a long length of channel and/or a high pressure-driven carrier fluid flow velocity may be required for merging to occur.

To provide a better method of controlling the interaction of isolated compartments in microfluidics, a three phase system may be used. The three phase system can enable better control of merging and mass transfer between compartments, as is described below.

FIG. 1 shows an example of a three phase system in a channel formed by channel (or ‘tube’) walls 20. The three phase system, also referred to as a double emulsion, consists of discrete compartments of a first fluid phase 10, also referred to as the reagent compartments (for example an aqueous phase), contained within a discrete compartment of a second fluid phase 12, also referred to as the buffer phase or separating compartment (for example silicone oil or linseed oil), which in turn is contained within a third continuous phase 14, also referred to as the carrier phase or carrier fluid (for example fluorocarbon). The first and second fluid phases are immiscible, and the second and third fluid phases are immiscible. The carrier fluid 14 wets the tube wall 20 of the channel material. The fluid phases can be liquid or gas phases.

A number of reagent compartments 10-1 10-2 10-3 10-4 of the first phase are contained within a single separating compartment 12 of the second phase. The different reagent compartments 10-1 10-2 10-3 10-4 are miscible and therefore collectively considered to be of the same phase 10, but their composition varies from reagent compartment to reagent compartment for different reagents. The reagent compartments 10 occupy the central region of the channel 20, and therefore move faster than the separating compartment 12, as described above.

In the example illustrated in FIG. 1 the reagent compartments 10-1 10-2 10-3 10-4 have similar properties with respect to their behaviour in the pressure driven flow, and all move within the separating compartment 12 at the same speed, until the compartment 10-1 farthest downstream arrives at the downstream end of the separating compartment 12, at the interface 16 between the separating compartment 12 and the carrier fluid 14. At the interface 16 the foremost reagent compartment 10-1 is confined since it cannot pass through the interface 16, as is explained in more detail below. Therefore that reagent compartment 10-1 is constrained to move at the same velocity as the separating compartment 12, while all other reagent compartments 10-2 10-3 10-4 continue to travel at a higher velocity than the separating compartment 12 due to separating/reagent fluid film region 19 between the reagent compartments 10 and the separating compartment 12. Eventually the next reagent compartment 10-2 catches up to the foremost reagent compartment 10-1, and merges with it, allowing the reagents to mix. The upstream reagent compartments move toward the front of the separating compartment 12, and one by one merge together, sequentially mixing in reagents contained in the different reagent compartments 10-1 10-2 10-3 10-4.

By selecting the spacing between the reagent compartments 10 and the pressure driven flow in the channel 20 the times at which each of the reagent compartments 10 merges with the others can be controlled.

As described above, merging of the reagent compartments 10 can be suppressed by using an appropriate surfactant of suitable quantity to create a surfactant/lipid bilayer barrier between the reagent compartments 10, in which case controlled diffusion occurs when the reagent compartments 10 come into contact with one another.

In the system shown in FIG. 1 two distinct film regions are present. The film region between the channel wall 20 and the separating compartment 12 is termed the carrier/separating fluid film region 18. As mentioned above, a second separating/reagent fluid film region 19 is formed between the reagents 10 and the separating compartment 12 boundary to the carrier fluid 14.

The carrier/separating fluid film region 18 can ensure that the reagent compartments 10 (containing for example different patient samples) never come in contact with the wall 20 and hence the same channel can be used to process multiple independent samples without possibility of cross contamination between separating compartments 12.

The separating/reagent fluid film region 19 between the reagents 10 and the separating compartment 12 is created as the fluid phase that forms the separating compartment 12 behaves like a solid wall relative to the reagent compartments. Therefore, as described above, each reagent compartment 10 within the separating compartment 12 moves at a higher velocity than the interface and therefore catches up with the next reagent compartment and merges if required.

Alternatively the reagent compartments 10 each have different properties with respect to their behaviour in the pressure driven flow. As set out above, the speed at which the individual reagent compartments 10 travel can be controlled for example by changing the interfacial tensions. Different reagent compartments 10 with different capillary numbers move at different relative velocities through separating compartment 12 in accordance with their film thickness, length, surfactant at interface and viscosity ratio. Therefore in addition to selecting the spacing between the reagent compartments 10, selection of the properties of each reagent compartment 10 can control merging and mixing of the reagent compartments 10 as they flow within the separating compartment 12. When all sample fluids are approximately the same density, the variation in interfacial tension between samples (either naturally or using surfactants/chemicals) can be controlled to initiate reactions in a controlled manner.

Alternatively surfactant concentrations can be controlled locally within the separating compartment 12 through either varying the concentration of surfactant between reagent compartments 10 or varying the surfactant concentration within the reagent compartment 10. Using this technique some reagent compartments 10 can be made to coalesce at the required time while others can be made to come into contact with each other and allow mass diffusion between them within the same separating fluid compartment 12. The rate of mass transfer between reagent compartments 10 can be controlled by varying the physical distance between reagent compartments 10 (or chemical concentration) within the separating fluid compartment 12, or varying the properties of the separating fluid itself such as surfactant concentration. The result is a number of independent separating compartments 12 within a channel which can allow communication between individual reagent compartments 10 within each separating compartment 12. By varying the properties of the carrier fluid 14 it is also possible to control the distance, merging and communication between the separating compartments 12.

As mentioned earlier, it should be noted that in other similar examples the reagent compartments 10 may comprise a solid phase (or may partially contain a solid).

Provided the volume of the compartments is small enough that the effect of gravity on the compartments is negligible, the interaction between compartments is based only on interfacial tension effects, and consequently the volume of the compartments has no effect on the behaviour, and the compartments can be controlled in the same manner independent of the compartment size. This has been demonstrated with droplet volumes ranging from ˜1 nl to ˜2 μl respectively in tubes of diameter 50 μm to 620 μm.

Changing the flow direction allows the reagent compartments to return to their original position and spacing between them as long as no reagent compartment has reached the front of the separating compartment. Such systems can be made parallel by adding multiple channel systems. High throughput can be achieved both by loading multiple separating compartment in sequence and also by adding additional channels in parallel. Tens of channels can be operated in parallel with a single pump, in particular in the case of channels formed of simple tubes.

Each reagent compartment can be recovered at the channel outlet and detailed analysis performed using conventional techniques. Further manipulation of a droplet outside of the tube is possible, as is long term storage of droplets for example in well plates.

The creation of double emulsions containing reagent compartments has been demonstrated in microfluidic devices using flow-focussing junctions (with a variety of fluids, hydrophobic and hydrophilic surfaces). Due to the method of manufacture the emulsion is however typically limited to a single reagent compartment per separating compartment. If the described devices were adapted to form multiple reagent compartments per separating compartment, then due to the method of manufacture the reagent compartments would necessarily all be of the same composition.

Formation of double emulsions containing multiple reagent compartments has been demonstrated in microfluidic devices with co-axial flows combined with the intelligent use of surfactants. In the co-axial flow device multiple reagent compartments within the same separating compartment are possible, but due to the method of manufacture the reagent compartments are necessarily all of the same composition. In order to prevent merging of sequential reagent compartments only negligible fluid property variations are possible.

None of these known methods of producing double emulsions in microfluidic devices provides control of the spacing between the reagent compartments, or indeed of the positioning and interaction between the reagent compartments within the separating compartment, nor would this be desirable as it would cause the already complex channel networks required to be even more complex.

In known double emulsion devices the droplet generated (both the reagent compartments and also the separating compartment) is of smaller length in the flow direction than the channel width. The reagent compartments are not made to travel in a channel that constricts them into elongate compartments, nor would this be desirable as it would cause the laboriously produced reagent compartments—of the same composition—to merge, to no particular purpose. Unlike conventional three phase microfluidic systems that generate spherical drops within a carrier spherical drop, the described three phase system functions on the basis of a slug flow, where the length of slugs is at least the dimension of the channel geometry, under which condition thin film formation occurs. The length in the flow direction is equal to or greater than the channel diameter for the relative motion to be controllable.

Instead of using multiple reservoir aspiration to produce the three phase system as described above, a conventional device can be adapted to combine first a microfluidic/microchannel network to produce a variety of different reagent compartments in a particular arrangement (controlling both spacing and sequence of the reagent compartments), and then feed the reagent compartments into a microfluidic system for generating an emulsion. This would require a complex channel network with sophisticated control of a number of auxiliary equipment, and is therefore larger and more cumbersome, expensive, difficult to operate, and more prone to error and failure.

In order to ensure the different compartments are appropriately positioned in the channel, an aspiration based method of forming the compartments is now described, which is suitable for the aspiration of both liquid and gas (i.e. fluids) in the present invention.

The three immiscible fluids are aspirated in the desired sequence into a channel. A simple one dimensional channel requiring no junctures, with a single inlet, is suitable for aspiration. To effect aspiration, that is an inflow of fluid into the channel opening, a hydrostatic pressure difference can drive the inflow with gravity as the driving force, or capillary effect can be employed to aspirate fluids, or external pumping or vacuum devices can be applied to cause a flow. The different fluids can be aspirated from different, separated reservoirs (e.g. by sequentially bringing the channel inlet into fluid communication with different fluid vessels). Alternatively, the different fluids can be aspirated from a single reservoir that contains different immiscible phases, as shown in FIG. 2. In this example different phases 22 are aspirated by moving the channel 20 inlet through different phases 22-1 22-2 22-3 22-4 held in a vessel 24.

To generate the arrangement of compartments shown in FIG. 1, the first fluid aspirated 22-1 is the carrier fluid 14. A second immiscible fluid is aspirated 22-2 into the channel 20 to form the first part of the separating compartment 12. Then, a first reagent compartment 10-1 with the desired constituents of interest (e.g. cells, DNA, proteins, enzymes, chemicals, water, solvent, etc.) is aspirated 22-3, followed by another portion of the second immiscible fluid that is aspirated 22-2 to form a portion of separating compartment 12 adjacent the first reagent compartment 10. Then a second reagent compartment 10-2 with the desired constituents of interest is aspirated 22-4, followed again by a portion of the second immiscible fluid that is aspirated 22-2 to form a portion of separating compartment 12 adjacent the second reagent compartment 10-2. This process is repeated for all required reagent compartments 10. Finally, the first carrier fluid 14 is aspirated 22-1 again. By selecting the interfacial tensions between the first, second and third fluids a system is provided such that the separating fluid compartment 12 spontaneously engulfs the reagent compartments 10, and the carrier fluid spontaneously 14 engulfs the separating fluid compartment 12.

By selecting the amount of the second immiscible fluid aspirated 22-2 after each reagent compartment 10, the separation between the reagent compartments 10 can be controlled, and thus the duration of travel before mixing of the reagent compartments 10 occurs. The reagent compartments 10 need not be regularly spaced with equal intervals between them, as shown in FIG. 1, but can be closer or farther apart depending on the desired duration before merging.

In addition to providing ease of control of the arrangement of different compartments in a channel, the aspiration based method of forming compartments requires only a single channel with only minimal external equipment and no particular channel geometries, thereby providing cost, size and usability advantages over other methods of forming the compartments.

The aspiration based method of forming compartments is not limited to four reagent compartments as shown in FIG. 1, but can be extended to any number of reagent compartments, with different constituent components in each of the different reagent compartments.

The sequence of carrier fluid, reagent, separating fluid as described above can be repeatedly aspirated into a channel to create a number of independent reagent compartments engulfed by the separating compartments engulfed by the carrier fluid, with each containing the same/similar or unrelated constituents. In an example, each separation compartment contains first a sample that is being investigated, with a different sample for each separating compartment, and in each separation compartment there are three other reagent compartments that contain always the same three different reagents used in the analysis of the samples.

Now the interfacial tension requirements of the different phases are considered in more detail. For the interface between three immiscible phases to be in equilibrium requires that the Neumann triangle be satisfied. This can be stated as a requirement that the interfacial tension γ between any two fluids cannot be greater than the combination of the interfacial tensions between the other fluids and may be expressed as the following inequality

γ₁₋₂<γ₁₋₃+γ₂₋₃

This inequality has been used to identify suitable spacers to prevent merging of water droplets in microfluidic devices. However, if γ₁₋₂ is greater than the sum of γ₁₋₃ and γ₂₋₃, then fluid 3 forms the interface between fluids 1 and 2 which may be used to create an engulfing effect of one fluid on another.

The micrographs in FIG. 3 show two different cases of a system with three immiscible fluid phases within a capillary of 600 μm diameter, where the flow direction is from left to right. The three phases are (i) water, (ii) FC40 with or without surfactants, and (iii) silicone oil. The top image shows the case (FC40 with surfactants) that satisfies the Neumann triangle:

γFC40surfactant/water<γFC40+surfactant/silicone oil+γsilicone oil/water.

The three phases exist in equilibrium in a triple interface. The lower image shows the case (FC40 without surfactants) that does not satisfy the Neumann triangle:

γFC40/water>γFC40/silicone oil+γsilicone/water.

The silicone oil forms an interface between the water and the FC40, and in doing so engulfs the water plug. In the right of the image silicone oil breaking away from the water droplet is visible. The outcome is a water droplet engulfed by the silicone oil, which is in turn engulfed by the FC40.

In multi-phase microfluidic flow systems where the inequality of the Neumann triangle is not satisfied, by virtue of selection of suitable fluid properties and control thereof, sophisticated control of fluid interactions can be enabled.

Now an example of a system as described with reference to FIG. 1 is described in more detail.

A PTFE tube 20 filled with fluorocarbon FC40 14 has an alternating stream of water 10/silicone oil 12 droplets aspirated into it. The channel diameter is typically about 0.6 mm, but can be for example 2 orders of magnitude smaller or larger. The interfacial tensions between FC40/water, FC40/silicone oil and water/silicone oil are measured to be 44 mN/m, 4.3 mN/m and 25.9 mN/m respectively using the pendant drop technique. The result is a microfluidic system where the fluorocarbon FC40 14 wets the capillary wall 20 and engulfs the silicone oil 12, which in turn engulfs the water droplets 10 as shown schematically in FIG. 1, time 1. Therefore the system consists of aqueous droplets 10 within a silicone oil droplet 12 within a FC40 carrier fluid 14. In this flow structure, created by using the interfacial tension effect at the microscale, the velocity of the foremost aqueous droplet 10-1 is constrained as it cannot pass through the silicone interface 16, while the velocity of subsequent aqueous droplets 10-2 10-3 10-4 (when γ is equal) is greater than the mean velocity of the silicone oil droplet 12 (and hence the foremost droplet 10-1). The reason for this higher velocity level is the presence of a thin film 19 between the water droplets 10 and the FC40 14. The velocity difference is dependent on the film thickness which can be shown to scale with Ca^{2/3} as described above and hence the relative velocity between the foremost droplet 10-1 and the subsequent droplets 10-2, 10-3 and 10-4 can be used to control coalescence of any number of droplets 10-n.

FIG. 4 shows measurements of the excess velocity of the aqueous droplets 10 engulfed in 10 cSt silicone oil 12 engulfed in FC40 14 relative to the mean velocity of the carrier fluid (FC40) 14 for fluid combinations of FC40, 10 cSt silicone oil and water over a range of carrier fluid mean velocities. Each data point represents an average of velocity measurement of at least ten droplets 10. The typical mean velocity of the flow in the channel 20 in the illustrated example ranges from 2-20 mm/second, but can be for example 3 orders of magnitude smaller, or it can be larger. In order to determine the necessary spacing between two reagent compartments 10 in order for mixing to occur after a desired period, the velocity difference between the droplet 10-1 and the following droplet 10-2 for a given mean velocity of the carrier fluid 14 can be determined from the graph in FIG. 4. The distance between the reagent compartments 10 can then be calculated by multiplying the determined velocity difference by the desired period of time before mixing is to occur.

FIG. 5 shows detection of a separating compartment 12 with 50 reagent compartments 10 for a 50 step reaction using this engulfing effect. The photodiode output voltage for different fluids/droplets passing the sensor region is indicated, allowing inference of the phase sequence within the tubing 20. In the example shown in FIG. 5, 51 droplets 10 are engulfed by a continuous silicone oil fluid separating compartment 12, which in turn is engulfed by a continuous FC40 fluid phase 14. The inset image shows photodiode voltage within the water droplet and silicone oil region in more detail. In this example each droplet 10-2 10-3 . . . 10-51 merges with the first (foremost) droplet 10-1 due to the velocity difference between the first 10-1 and subsequent droplet 10-n (as shown in FIG. 1), hence enabling a controlled 50 step reaction.

Now variants of the system according to FIG. 1 are described.

FIG. 6 shows a system where one of the fluids is a gas phase instead of a liquid phase. A dry channel 20 containing gas 15 (e.g. ambient air) replaces the carrier fluid 14 (e.g. a fluorocarbon) in the example described with reference to FIG. 1. The separating fluid 12 is aspirated or injected into the channel followed by immiscible reagent compartments 10-1 10-2 10-3 (e.g. aqueous solutions of different reagents). The immiscible separating fluid 12 forms films 19 around the reagent compartments 10-1 10-2 10-3. Consequently the reagent compartments 10 move at a faster velocity than the separating fluid 12, therefore the first reagent compartment 10-1 eventually catches up with the gas/separating fluid interface 17. Upon reaching the interface 17 the reagent compartment 10-1 is confined and forced to travel at the same velocity as the interface 17, which is a lower velocity than subsequent reagent compartments 10-2 10-3. Therefore the subsequent reagent compartments 10-2 10-3 (which have a higher velocity than the interface 17 due to the film region 19) catch up and merge with the first reagent compartment 10-1 confined at the gas/separating fluid interface 17. This process can then be repeated to have an unlimited number of reagent compartment 10-1 10-2 . . . 10-n reactions at pre-defined times or positions within the channel 20 through controlling the initial distance between such reagent compartments 10. Surfactant can be used to prevent the merging of the reagent compartments 10 and in this case the reagent compartments 10 form a series of “touching reagent compartments” 10 separated by surfactant molecules which can be designed to allow controlled diffusion between said reagent compartments 10 of small molecules.

The channel walls 20 in the portion of the channel containing the gas phase 15 are dry; the separating fluid 12 wets the channel walls 20. In order to ensure the walls are sufficiently dry for the necessary interface to form, the channel needs to be sufficiently dry, and may not still be wetted from a foregoing fluid in the channel. A mere bubble of gas is not necessarily sufficient to form a suitable interface.

FIG. 7 shows an example of a three phase system that allows the merging of compartments 3, 4, 5 in a controlled manner without a separating compartment. This example is similar to the example described with reference to FIG. 1, except that here the reagent compartments 3, 4, 5 are engulfed directly by the carrier fluid instead of being engulfed by a separating compartment. A slow-travelling compartment 30, for example one having a relatively high interfacial tension, is positioned downstream of the reagent compartments 10, which acts to constrain the faster travelling reagent compartments 10 by performing a similar function to the gas/separating fluid interface 17 described with reference to FIG. 6. By providing a blocking compartment 32 that is immiscible with both the slow-travelling compartment 30 and the reagent compartments 10 between the slow-travelling compartment 30 and the reagent compartments 10, the slow travelling compartment 30 does not have to be immiscible with the reagent compartments 10.

More specifically, the reagent compartments 10 cannot overtake the blocking compartment 32 and therefore it confines the first reagent compartment 10-1 that catches up with it and forces that reagent compartment 10-1 to travel at the same velocity. The subsequent reagent compartments 10-2 10-3 then in due course catch up with the first reagent compartment 10-1 and merge one by one, as illustrated in FIG. 7. The merging occurs irrespective of the properties of the three different reagent compartments 10. For example, the carrier fluid may be a fluorocarbon, both the reagent compartments and the slow-travelling (high interfacial tension fluid) compartment may be aqueous, and the blocking compartment may be a gas. Such a three-phase system can provide high stability.

Alternatively, the slow travelling compartment 30 and the single blocking compartment 32 could be combined as a single compartment selected such that it is immiscible with, and moves slower than, the reagent compartments 10. Again, such a slow-travelling blocking compartment (not shown) would perform a similar function to the gas/separating fluid interface 17 described with reference to FIG. 6 due to it being immiscible with the reagent compartments 10.

Also with reference to FIG. 7, by tailoring the interfacial tension of the carrier fluid portions 14 (labelled b, c, and d) between the reagent compartments 10 the speed of the three reagent compartments 10 can be controlled as desired. For example the same carrier fluid 14 can be aspirated with different surfactant concentrations between reagent compartments 10. The reagent compartments 10 can then move at different velocities and the location/sequence/timing of merging can be controlled between sequential reagent compartments 10-1 10-2 10-3. For example, either reagent compartments 10-1 and 10-2 or reagent compartments 10-2 and 10-3 can be made to merge first, depending on the surfactant concentration of the carrier fluid 14 adjacent each reagent compartment 10 and the reagent compartment fluid properties. In particular the velocity of each reagent compartment 10 depends on the interfacial tension between it and the downstream carrier fluid 14. Similarly the speed of the slow-travelling compartment 30 can be adapted by tailoring the interfacial tension of the carrier fluid 14 portion downstream of the slow-travelling compartment 30.

In another alternative system to the three-phase system shown in FIG. 1, the separating fluid 14 between reagent compartments 10 may comprise different miscible fluids, or the same fluid containing a different level of surfactant, analogous to the different portions b, c, d of carrier fluid described with reference to FIG. 7. Similarly, this can enable additional control of individual reagent compartments 10-1 10-2 10-3 to move at different velocities within the separating compartment 12, and allow any desired sequentially flowing reagent compartments 10-n to merge in any order irrespective of their position within the separating compartment 12 or carrier fluid 14.

FIG. 8 shows a system where additional phases are added to provide more separating compartments within droplets. In this system a fourth immiscible fluid forms super-separating compartments 34 containing sub-separating compartments 12-1 12-2 in order to control reagent compartments 10 to merge in any desired sequence. As shown in FIG. 8, reagent compartments 10-3 and 10-4 merge together to form a first merged reagent compartment, and reagent compartments 10-1 and 10-2 merge together to form a second merged reagent compartment. Then the sub-separating compartments 12-1 12-2 merge before the two merged reagent compartments merge to form a single reagent compartment. The sequence in which the reagent compartments 10 merge can be controlled according to any arbitrary sequence of an arbitrary number of reagent compartments 10. Appropriate fluids are identified by using the interfacial tension relationship as described above. The concept can be expanded using further immiscible fluids forming further sub- and super-separating compartments.

In an alternative, the fourth super-separating compartment 34 fluid and the reagent compartments 10 fluid can be miscible fluids, e.g. both aqueous based, separated by an immiscible fluid and hence transfer of material across the film region separating the two fluids can occur.

FIG. 9 shows a system where, in the initial configuration, the reagent compartments 10 are not contained within the separating compartment 12. Instead the reagent compartments 10 (e.g. different aqueous solutions) as well as the separating compartment 12 (e.g. a silicone oil) are all contained in and immediately in contact with the carrier fluid 14 (e.g. a fluorocarbon). The separating compartment 12 is initially located upstream of the reagent compartments 10. The properties of the separating compartment 12 are chosen such that the separating compartment 12 occupies a narrow central region of the channel 20 than the reagent compartments 10. Consequently the separation compartment 12 moves at a faster speed in a pressure-driven flow than the reagent compartments 10. Accordingly the separation compartment 12 eventually catches up to the rearmost reagent compartment 10-3. The interfacial tensions of the three phases are selected such that the separation compartment 12 spontaneously engulfs the reagent compartment 10-3 and forms a thin film around it 19, separating the reagent compartment 10 from the carrier fluid 14.

The reagent compartment 10-3 that is thus contained in the separating compartment 12 adapts by behaving as if the separating compartment 12 were a new solid boundary, and now occupies a narrower central region of the channel 20 than the separation compartment 12. As described above, the reagent compartment 10-3 cannot pass the interface 16 between the separation compartment 12 and the carrier fluid 14, and therefore remains constrained at the front of the separating compartment 12. The reagent compartment 10-3 and separating compartment 12 continue to travel at a greater velocity than the reagent compartments 10-1 10-2 alone since the reagent compartment 10-3 is now inside the separating compartment 12. One by one the reagent compartments 10-2 10-1 are engulfed from the rear by the separating compartment 12 in sequence of their arrangement in the channel. Each new reagent compartment 10-2 that is engulfed by the separation compartment 12 may merge with the reagent compartment 10-3 already inside the separating compartment 12.

Alternatively, merging of the reagent compartments 10 within the separation compartment 12 can be suppressed by using an appropriate surfactant of suitable quantity to create a surfactant/lipid bilayer barrier between the reagent compartments 10, in which case controlled diffusion occurs when the reagent compartments 10 come into contact with one another within the separation compartment 12.

FIG. 10 shows a system where a fourth immiscible fluid is introduced to prevent the reagent compartments 10 within the separating compartment 12 from coming into contact with each other. Sample fluids could be fluorocarbon as carrier fluid 14, silicone oil as separating compartment 12, aqueous based fluids as reagent compartments 10 and vegetable oil as fourth immiscible fluid compartments 36.

Instead of or in addition to using the fourth immiscible fluid described above for separation of reagent compartments 10, one or more such compartments 36 is included in each separating compartment 12 for the purposes of indexing. This is particularly useful where a number of separating compartments 12-1 12-2 differ between one another, for example with each separating compartment 12 containing a particular patient sample. Especially if the separating compartments 12 are released from the channel 20 and the ordering of the separating compartments 12 changes, indexing of the individual separating compartments 12 in order to identify the particular content of the separating compartments 12 for post analysis. This can be particularly important for large numbers of different separating compartments 12. Such an indexing compartment 36 is contained within a separating compartment 12 and is of a fluid such that it does not merge with any of the reagent compartments 10. The indexing compartment 36 can enable identification on the basis of for example molecule free indexing (reagent compartment 10 size/volume) or composition (e.g. fluorescent gradient reagent compartments 10), or reagent compartment 10 number. Alternatively a number of indexing compartments 36 can combine to encode an identifier (e.g. a binary identifier). Indexing compartments 36 can be formed by aspirating a single or a number of indexing compartments 36 to each separating compartment 12 and thereby being able to identify the exact original constituents of each separating compartment 12. The Indexing compartments 36 can be, but do not need to be, immiscible with the reagent phase 10. For example the indexing can be an aqueous phase with varying fluorescent and size properties.

Alternatively, when the analysis is achieved entirely within a channel 20 and the arrangement of the different separating compartments 12-1 12-2 relative to one another is maintained, the indexing compartment 36 can be engulfed by the carrier fluid 14 instead of being contained within the separating compartments 12, as the association between indexing compartment 36 and separating compartment 12 is unambiguous.

FIG. 11 shows how the thickness of the separating compartment 12 surrounding the reagent compartment 10 (in the foremost separating compartment 12) can be controlled by reversing the flow direction to form a thin film 19 surrounding the reagent compartment 10. Considering the separating compartment 12-1 shown on the right hand side, upon reversing the flow direction (provided there is appropriate interfacial tension) the fluid in the separating compartment 12-1 that is now ahead (or ‘downstream’) of the foremost reagent compartments 10-1 in the new flow direction detaches from the rest of the separation compartment 12-1 thereby resulting in a reduced quantity of separating fluid 12-1 engulfing the reagent compartments 10 to the extent that no more than a thin film of the separating compartment 12-1 fluid engulfs the reagent compartment 10 in all directions. With the inclusion of suitable surfactants/phospholipids the formation of surfactant/lipid bilayers can be achieved. The creation of such bilayers would result in reagent compartments 10, now well defined vesicles, with a bilayer similar to that on live cells which can then allow the introduction of proteins, ion exchange into/through the bilayer to mimic live cells, or mass transport of interest across the bilayers.

Detachment occurs under suitable conditions with respect to interfacial tension forces and shear stress/drag forces (unlike engulfing, which is determined by interfacial tension alone).

FIGS. 12a-e show a system where four dimensional networks of reagent compartments can be built (with control over placement in three spacial directions and with control over placement and interaction in a time dimension) to examine the interaction of the constituents of each reagent compartment. After forming compartments surrounded by a bilayer, as described above with reference to FIG. 11 (or alternatively compartments containing reagents, as described above with reference to FIGS. 1 and 6 to 10), the channel outlet is positioned in a container containing a reservoir of fluid, and the compartments exit the channel into the reservoir. FIG. 12a illustrates droplet delivery to the reservoir. By moving the channel outlet within the reservoir each separating compartment is placed in any 3-D relative position to other separating compartments to allow communication between required separating compartments. The excess separating fluid may be miscible with the reservoir fluid, in which case the carrier fluid is immiscible and forms its own phase within the reservoir. Alternatively the carrier fluid is miscible with the reservoir fluid, in which case the excess separating fluid is immiscible and collects in its own phase of the reservoir. FIG. 12b illustrates the creation of a bilayer vesicle in the reservoir. FIG. 12c illustrates the placement of multiple vesicles in the reservoir to form a network of vesicles. FIG. 12d illustrates vesicles in porous/non-porous media, after they have been made to pass through a fluid interface between immiscible surfaces. FIG. 12e illustrates a particular vesicle in a network of vesicles having an index compartment to identify the particular vesicle.

Each reagent compartment delivered to the reservoir can have been formed from a number of reagent compartments merging during the journey to the channel outlet. In the example illustrated in FIGS. 12a-d, only a single reagent compartment is contained in the separating compartment. In FIG. 12e a number of reagent compartments are in the same separating compartment, for example as described with reference to FIG. 10 or with reference to indexing compartments. By containing one or more reagent compartments along with further functional compartments (such as an indexing compartment) within a separating compartment, upon release into the vessel the separating compartment can continue to contain all its constituent compartments and thus ensure their association together.

In an example each reagent compartment delivered to the reservoir contains different cells types expressing different molecules. In another example each compartment contains a number of sub-compartments, for example an indexing sub-compartment and a cell sub-compartment. The interaction between these separating compartments is probed by having the fluid properties of the buffer fluid in the reservoir porous to the molecules of interest. A porous buffer fluid is one that those molecules are soluble in, and/or diffusion of those molecules occurs in that buffer. All fluids are somewhat porous and can act as solvents under the right conditions. In the arrangement of the compartments in the buffer reservoir there is a layer of reservoir fluid between compartments and hence the reservoir fluid are soluble/porous to the molecules of interest. Therefore they must pass through the bilayer, then the reservoir fluid. For example silicone oil is highly porous to fluorescein however fluorocarbons are not porous to fluorescein.

In an alternative the buffer fluid in the reservoir could have properties that are non-porous to the molecules of interest and the separating compartments could be arranged in the desired 2D/3D structure, to represents a multicellular environment and/or with variation of gradients in molecules across the environment (e.g. reflecting a cancer lump where the outer cells have a high concentration of drugs while the inner ones have a lower concentration). When the desired arrangement is achieved, and required time has passed, the entire arrangement may be transferred to a buffer fluid which is porous to the molecules of interest, by varying the surface tension of the fluids interface. In this arrangement the non-porous/porous buffer fluid interface is such that it does not allow the separating compartments to pass through the interface, until the interface properties are modified and hence the separating compartments can transfer from the non-porous buffer solution to the porous buffer solution. This can be achieved through the addition of surfactant to the buffer region/s. The reverse, where the separating compartments move from the porous to the non-porous buffer fluid can be achieved using a similar methodology.

In another example the different compartments can be transferred from the channel outlet to either an unconfined surface or a reservoir to monitor the individual separating compartments over time. Evaporation of fluids form the compartments can be reduced or increased through either humidity control or choice of carrier and separating fluids. In particular, the different compartments can be transferred to standard biotechnology formats such as 96 well plate readers, PCR machines etc. for further analysis.

Each reagent compartment can be recovered and detailed analysis performed using conventional techniques with the aid of indexing of each separating compartment.

FIG. 13 shows a variant of a three phase system having a blocking compartment 32, constrained by a slow-travelling compartment 30. A train of reagent compartments 10-1 10-2 10-3, each having a different composition, are initially separated by a series of separating compartments 12 interspaced between the reagent compartments 10. Fluid is transported between adjacent reagent compartments 10 based on the film region 18 between the tube wall 20 and the separating compartments 12. As the system flows in the channel 20 the farthest downstream reagent compartment 10-1 is successively pumped into the adjacent upstream reagent compartment 10-2, until all the reagent compartments have merged together. By suitable selection of the blocking compartment 32 downstream of the first reagent compartment 10-1 leakage downstream can be minimised. This method can be used to generate artificial proteins/genes of any length.

FIG. 14 shows an example of providing multiple independent samples for mass spectrometry within the same tube. A number of protein/compound combinations (or other targets) are arranged as reagent compartments 10 within a channel/tube 20 by dipping between protein/compounds of interest within different wells, as well as separating fluids and carrier fluids 14. This produces a separating compartment 12 containing a train of reagent compartments 10 with different compounds to be screened. Under the influence of a fluid flow in the tube 20 the reagent compartments 10 merge as previously described. Once the sample for mass spectrometry has thus been prepared, the merged reagent compartments 10 are delivered to the mass spectrometer (not shown). To do so one of the ends of the tube 20 (either the inlet 20-1 or the outlet 20-2) can be pulled and modified to form a delivery device for the mass spectrometer. In the illustrated example the tube inlet 20-1 is formed into a tip, and accordingly the flow is reversed in order to deliver the reagent compartments 10 to the mass spectrometer. Both the carrier fluid 14 and the separating fluids can be volatile/low evaporating temperature fluids to minimise any potential contamination of the mass spectrometry results.

FIG. 15 shows a variant of the above-described multi-phase systems for exposing a substrate to a series of reagents. A chemical is bound to magnetic particles (or “beads”) 40 which are then fixed in position (relative to the channel wall 20) by an external magnet (not shown). A train of reagent compartments 10-1 10-2 10-3, each having a different composition, are each separated by a series of separating compartments 12 interspaced between the reagent compartments 10. As the system flows, the magnetic particles 40 and hence any attached molecules/chemical media are exposed to each of the reagent compartments 10 in a defined sequence. For example reagent compartments 10 can contain wash media or media to bind/react with the chemical attached to the magnetic particles 40. Other forms or immobilisation of a substrate to the tube wall 20 can be used, but the immobilisation by way of magnetic particles 40 is particularly convenient as it provides ease of control of the location of immobilisation and the release of the magnetic particles 40 subsequent to their immobilisation.

In all of systems described above the following operations and alternatives are possible:
the flow may be stopped or reversed while maintaining the existing structure.
the local interfacial tension may be modified by addition of high/low surfactant concentration drop and thereby modify the structures from engulfing to non-engulfing, and even cause an inversion of the phases.
Reversing the flow can result in the breaking away of the first oil/water droplet within the separating fluid/aqueous fluid train when the interfacial tension of the first fluid with the carrier fluid is controlled relative to the interfacial tension of the reagent fluid with the carrier fluid/separating fluid.
Changing tube material can be used to vary the fluid that is in immediate contact with the tube wall (generally the carrier fluid); for example the carrier fluid can be hydrocarbon/silicone oil while the separating fluid can be a fluorocarbon.
Magnetic particles can be used to transfer mass/molecules between any compartments/drops in any of the above arrangements.

In another example of an application of a dilution series for RT-PCR (reverse transcriptase PCR) amplification is prepared. Instead of preparing sample by conventional pipetting, the five required reagents (a buffer, primers, RT-Taq and DNA-Taq enzymes, and template) are loaded in six separating compartments. Each separating compartment contains five reagent compartments, one reagent compartment for each of the five required reagents, appropriately spaced and sequenced. From separating compartment to separating compartment the amount of template varies so as to produce the dilution series. As the flows along a tube the reagent compartments merge and mix to create six mixtures in a dilution series. At the tube outlet the resultant six mixtures are deposited in six different wells of a 96-well plate alongside their analogues prepared conventionally by pipetting. After amplification in a PCR cycler and gel electrophoresis, the dilution series prepared in the three phase system is observed to be identical to the dilution series prepared conventionally by pipetting. By producing the dilution series in a three phase system rather than by pipetting the biocompatibility risks of working with biological matter can be reduced, as the reagents are isolated (by the separating compartment, the carrier fluid and the tube) from the environment.

### Droplet/Emulsion Generation

FIGS. 16 and 17 show examples of multi-phase systems for generating an emulsion, similar to what has been described previously.

In the example of FIG. 16, a three phase system is contained in a channel formed by channel (or tube) walls 20. A carrier fluid 14 of a first phase directly encloses a separating compartment 12 of a second phase, and a further discrete reagent (‘feeding’) compartment 2010 of a third (for example aqueous) phase is contained within the separating compartment 12. The first and second fluid phases are immiscible, and the second and third fluid phases are immiscible. The carrier fluid 14 wets the channel wall 20.

In this example, instabilities are created at an interface 2014 between the reagent compartment 2010 and the separating compartment 12 so as to cause shedding of small emulsion compartments 2012 from the reagent compartment 2010 into the separation compartment 12. This can enable emulsification of a larger compartment 2010 into smaller compartments 2012. The individual emulsion compartments 2012 can be of volumes in the range of femtolitre to picolitre. The rate at which emulsion compartments 2012 are generated from the reagent compartment 2010 can be in the range of kHz. Instabilities that result in the shedding of the emulsion compartments 2012 may be created by adding suitable surfactants to the separating compartment 12, thereby lowering the interfacial tension with the reagent compartment 2010.

Here, the reagent compartment 2010 may be aqueous, for example, and is engulfed by a larger separating compartment 12 of the mineral-oil mix used for emulsion polymerase chain reaction (PCR), which is enclosed in FC40 carrier fluid 14. The resulting interfacial instability causes small aqueous droplets to be shed into the separating compartment 12. For example, a 20 nl reagent compartment 2010 provided in a 150 μm diameter tube may yield an emulsion in which aqueous emulsion components 2012 have volumes ranging from femtolitre (fl) to picolitre (pl). In an alternative, the PCR oil (which can permit permeation of small molecules) is replaced with mixtures known to be suitable for generating emulsions containing proteins (such as a mixture of tetradecane, EM180 and Span® 80); in this case emulsions are produced that both remain stable during thermal cycling and can retain fluorescent molecules for at least two weeks.

To generate an emulsion as described above only a single tube with a single inlet is required, without requiring a T-junction or other flow focusing device, a complex channel of networks with multiple syringe pumps controlling the flow, or any mechanical means such as agitation, as previously used.

The generated emulsion is contained with the separating compartment 12, which means that each aqueous reagent compartment 2010 and separating compartment 12 can act as an independent sample, free of contamination from other samples. With conventional emulsion generation such containment would require a complex setup including a number of parallel droplet generating devices with all associated auxiliary equipment and connectors.

Subsequent size filtering (for example as described above with reference to FIG. 17) allows selection of emulsion compartments 2012 of a more homogeneous size.

FIG. 17 shows another example of a multi-phase system for generating an emulsion. In this example, a blocking compartment 32 having a phase (e.g. air) that is immiscible with an (aqueous) reagent compartment 2010 upstream confines the reagent compartment 2010 to travel at the same (slower) speed as the blocking compartment 32. Both the blocking compartment 32 and reagent compartment 2010 are enclosed within a carrier fluid 14 within a conduit 20. A separating compartment 12 having a phase (e.g. oil) that is immiscible with the reagent compartment 2010, but that is also enclosed within the carrier fluid 14, is provided spaced upstream of the reagent compartment 2010. After a predetermined period of time, the separating compartment 12 catches up with the reagent compartment 2010 which is confined by the blocking compartment 32. Adding a surfactant to the separating compartment 12 creates instabilities at the (“oil:aq”) interface between the separating compartment 12 and reagent compartment 2010, which results in small emulsion compartments 2012 being shed into the separating compartment 12. The emulsion compartments 2012 are polydisperse, having volumes ranging from femtolitre (fl) to picolitre (pl), and they can contain single particles the size of mammalian cells for single 6 micron particles.

In another example (not shown) a number of reagent compartments 2010 can be made to merge and react as described with reference to FIG. 1. Subsequently the composition of the separating compartment 12 is changed (for example by causing the separation compartment 12 to merge with another separating compartment 12 containing appropriate surfactants) such that the interfacial tension with the reagent compartment 2010 changes and shedding occurs, resulting in the production of an emulsion of the reacted mixture. By merging reagent compartments 2010 upstream of the emulsification as described here, accurate temporal control of perturbation of samples (e.g. cells) before emulsification can be achieved.

### Mass Transfer

When working with live media in microfluidics, currently it is not possible to continuously refresh the surrounds of such media. For example a cell culture in a reagent compartment consumes the nutrients supply and excretes waste products hence changing its environment with time.

FIG. 18 shows a system where there are different portions of carrier fluid 1100 that are miscible but which are separated by immiscible compartments 1102. The environment of a carrier fluid portion 1100-3 is controlled through flow from a neighbouring carrier fluid portion 1100-2 with a different composition. The film region 1104 of a separating compartment 1102-2 between the different portions 1100-2 1100-3 of carrier fluid allows an exchange of matter (via advection) between the different portions. By suitably selecting the properties of the separating compartment 1102-2 the thickness of the film region 1104 can be controlled, which in turn allows control of the mass (or heat) flow around the separating compartment 1102-2 from the downstream portion 1100-2 to the upstream portion 1100-3. The film region 1104 thus forms a pathway that acts as a unidirectional flow pathway between neighbouring carrier fluid portions 1100, where the size of the flow pathway 1104 and hence the flow rate through it can be selected. The flow rate between neighbouring carrier fluid portions 1100 can be selected at femtolitre (fl) to microliter (μl) accuracy. The integrity of the different portions of carrier fluid 1100 is maintained as the composition is varied. If the flow in the channel is stopped, then the advection ceases.

For example, the carrier fluid 1100 is an aqueous phase (with the channel walls 20 suitably hydrophilic) and in one of the portions 1100-3 a cell culture is contained. The cell culture portion 1100-3 can have a continuous refreshment of its culture media supplied by an adjacent portion 1100-2 through the film region of a separating compartment (e.g. of silicone oil, fluorocarbon or air), while used medium waste can be extract from the cell culture portion 1100-3 at the same rate to another upstream portion 1100-4, thereby maintaining a constant internal environment in both size and chemical properties. Alternatively, the cell culture environment can be fed from several downstream portions 1100-1 1100-2 to allow a controlled variation of the cell culture portion 1100-3 environment for perturbation of the cell culture 1100-3 by a compound for screening purposes. Such systems enable maintaining a fixed cell culture environment and open up new potential in microbiology, toxicity and drug screening. This system can also be used to probe 3D cell culture for controlled diffusion between samples with different proteins/cell lines for example.

FIG. 19 shows a system where there are again different portions of carrier fluid 1100 that are miscible but are separated by immiscible separating compartments 1102. The carrier fluid 1100 wets the channel wall 20 surface. One sample portion of carrier fluid 1100-1 contains a sample with a distribution of particles 1106. Depending on the flow rate the thin film region 1104 varies in thickness and hence this can be used to provide a mechanism for separation of poly-dispersed particles into mono-dispersed portions. By suitably selecting the properties of the separating compartment 1102 the thickness of the thin film regions 1104 can be controlled, which in turn allows control of the mass flow around the separating compartment 1102 from the downstream portion 1100-1 to the upstream portion 1100-2. By selecting different properties of the separating compartments 1102, the separating compartment 1102-1 adjacent the sample portion of carrier fluid 1100-1 can have a relatively wide thin film region 1104-1 and allow very small as well as medium sized particles to pass, and retain only the very large particles. The next separating compartment 1102-2 upstream then has a slightly narrower thin film region 1104-2, and allows only very small particles to pass, and retains the medium sized particles. Thus size dependent separation is provided. Several diseases can be characterised by the size of the particles in blood flow and this method enables for example isolations of specific blood particle sizes for detailed investigation. In another application size dependent separation polydisperse vesicles can be provided.

FIG. 20 shows a system where a three phase system (as described above) is adapted for a mass transfer system. The reagent compartments 1110 and the separating compartment 1102 as described with reference to three phase systems are inverted, with different (miscible) portions of the reagent phase 1110 being separated by separation compartments 1102. These initial portions of the reagent phase 1110 are originally formed either from discrete drops or dipping between different reservoirs. Thus individual portions of the reagent compartment 1110 can contain an environment that is controlled through flow in the film regions 1108 from the downstream portion 1110-1 to the upstream portion 1110-2. For example, a cell culture in one of the reagent compartment portions 1110-2 can have a continuous refreshment of its culture media supplied by adjacent reagent compartment portion 1110-1 through the film region 1108-1 of a separating compartment 1102-1, while used medium waste can be extracted at the same rate to another reagent compartment portion 1110-3, thereby maintaining a constant internal environment in both size and chemical properties.

Alternatively, the cell culture portion may be fed from several downstream portions to allow a controlled variation of the cell culture environment for screening purposes. A range of different molecules can be arranged in different reagent portions to undertake screening with varying temporal concentrations of desired molecules. Because the reagent is completely contained within the carrier fluid and at no point directly contacts the channel walls, there is no risk of fouling of the channel (as can occur in the example described with reference to FIG. 13). Also cross-contamination between different cell culture samples in different, non-connected reagent compartments is not possible as the carrier fluid separates the individual reagent compartments.

FIG. 21 shows measurements of the flow rate between individual portions of the reagent compartment as shown in FIG. 15 for two different diameters of channel. For fluid flow rates in the range of tens of μm to tens of mm an exchange across the separating compartment at a rate in the range of pL/s to sub μL/s is observed. At the same overall channel flow rate the exchange in the narrower channel (220 μm diameter) is approximately an order of magnitude smaller than in the larger channel (630 μm diameter). This demonstrates the relationship between the carrier fluid velocity and the flow rate between portions of the reagent compartment.

FIG. 22 shows a system where a three phase system (as described above) is adapted for particle sizing as described with reference to FIG. 14. The reagent compartment and the separating compartments 1102 as described with reference to three phase systems are inverted, with different (miscible) portions of the reagent phase 1110 being separated by separation compartments 1102. The different separation compartments 1102 act as bypass filters for particle sizes based on the film thicknesses between different portions of the reagent compartment 1110 and the separating compartments 1102. Initially a first portion 1110-1 of the reagent compartment contains a wide distribution of particles sizes 1106. The thickness of the film region 1108 between the separating compartments 1102 and the reagent compartment 1110 only allows a certain size distribution to pass through it. The thickness of the film region 1108 of each individual separating compartment 1102 can be controlled by selecting different fluids with varying properties as separating compartments 1102 and thereby having film regions 1108 of different thicknesses. Only particles 1106-2 smaller or about the same size as the thickness of the film region 1108-1 are able to pass through the film region 1108 as shown in FIG. 17. For given reagent compartment 1110 fluids the flow rate determines the film region 1108 thickness and hence this can be used to provide a mechanism for separation of poly-dispersed particles into mono-dispersed compartments.

The thickness of the film region 1108 between the separating compartments 1102 and the reagent compartments 1110, in effect the height of the pathway between reagent compartments 1110, is estimated as follows. The thickness of the film region 1108 relative to channel/tube 20 diameter is proportional to the Capillary number (Ca) to the power of ⅔. For tubes of 150-1000 μm inner diameter with average flow velocity of 0.25-6 mm/s the thickness of the film region 1108 is estimated in the range of 0.1-40 μm.

In a further example of a three phase system for particle sizing (not shown), fluids may be aspirated into a 150 μm PTFE tube in the following sequence (with the first being the leading compartment farthest downstream):
1. carrier fluid
2. gas (to control the maximum speed of subsequent droplets since it has the highest interfacial tension with the carrier)
3. aqueous fluid containing a mixture of 2 μm (“smaller”) and 10 μm (“larger”) particles
4. carrier fluid
5. separating fluid
6. filtered water
7. carrier fluid

As the sequence of compartments flow in the tube, the aqueous fluid compartment and the filtered water compartment merge as an engulfing aqueous channel (thickness ˜3 μm) forms around the separating fluid. After the aqueous channel is formed the larger particles remain in the leading aqueous compartment, downstream of the separating compartment, while the smaller particles migrate and accumulate in the lagging aqueous compartment upstream of the separating compartment, because only the smaller particles are small enough to pass through the aqueous channels that connect the leading and lagging parts of the merged aqueous compartment.

In an alternative system, magnetic particles can be used to move media from one part of a merged aqueous compartment to another and/or or between discrete aqueous compartments through the separating fluid as the flow moves them past the particles. This can be achieved by using a magnetic field to hold the magnetic particles in a fixed position as the compartments flow past. It is also possible to use a magnetic field to move magnetic particles from one part of a merged aqueous compartment to another and/or between compartments. In a further alternative system a further compartment containing drugs/markers may be added to the second half of a merged compartment during diagnostic applications.

FIG. 23 shows a further embodiment for moving magnetic particles (and their cargo) between reagent compartments through the separating compartments, and in this example, also through the carrier fluid to another reagent.

In this example, fifteen independent reagent compartments are arranged in a conduit (as shown centrally in the figure). The magnetic particles (‘beads’ in this example) are moved as follows:
a) the magnetic beads are moved from a first compartment through a first separating compartment 212-1 between three water compartments as ‘wash steps’;
b) the magnetic beads are then moved through carrier fluid 214 to the next ‘train’ of drops, enclosed in a further separating compartment 212-2 and a magnet 250 is used to attach Oligo 210-1. The beads are again washed by moving them through the separating compartment 212-2 between three further water drops;
c) while the system is flowing, initial drops labelled Oligo 210-2, 210-3, 210-4 and Gibson 210-5 have merged and the magnetic beads with the Oligo 210-1 attached may be transported through the carrier fluid 214 and separating fluid 212-3 and delivered into the merged compartment 210-5;
d) after a suitable incubation (for example 1 hour at 50 degs C.), the magnetic beads are moved to another train of drops in a further separation compartment 212-4, where they undergo three further washes, and are deposited into a final compartment 210-6 for collection or analysis.

This process is suitable for gene assembly with multiple wash steps.

With reference to FIG. 1, a magnetic field could be used to move magnetic particles from compartment 10-1 through the separating compartment 12 to compartments 10-2, 10-3 and 10-4.

With reference to FIG. 20, the movement of magnetic particles between reagent compartments can be also achieved through the film region by advection, wherein the magnetic particles never leave the compartment but rather are just transported between compartments within one super compartment.

In a similar three phase system to that shown in FIG. 17, the reagent compartments may initially contain different chemical constituents. The film regions of reagent compartment phase formed between the separating compartments and the carrier fluid result in fluidic pathways interconnecting the different reagent compartments. As the phases flow in the tube the separating compartments move toward one another and the different reagent compartments are progressively pumped into one another.

In the system shown in FIG. 22 and in other similar three phase systems the mass transport between portions of fluid can be controlled continuously at desired times and flow rates, as opposed to the systems described above where merging occurs at a discrete time. Such a three phase system can produce a pumping motion opposite to the flow direction between sequential reagent compartments.

An example of a three phase system for mass transport is now described in more detail. For any such system, the fluids interfacial properties should satisfy the inequality of:

γcarrier/separating>γcarrier/reagent+γseparating/reagent

An example of fluids used in such a three phase system is:
FC40+10% surfactant as carrier fluid
water+1% Triton X-100 as reagent
Tetradecane+0.5% Span® 80 as separating fluid

In another example the reagent compartment is water without a surfactant. In this example, the surfactant in the carrier fluid is selected to achieve a sufficiently low interfacial tension between the carrier fluid and the reagent compartment. In the case of the carrier fluid being a fluorocarbon such as FC40, a suitable such surfactant is Pico-Surf, with others being available. The flow rates between neighbouring reagent compartments is calculated based on the difference in velocity of the leading and subsequent droplets and depends on the carrier fluid mean velocity.

FIG. 4 shows an example of measured velocity differences between neighbouring compartments; such velocity difference values (together with quantification of the cross sectional area of the reagent compartments) can be used to calculate the flow rate in a film region. Experiments have shown that over four orders of magnitude of flow rates between reagent compartments can be provided, ranging from picolitres to microlitres per second, by selecting an appropriate carrier fluid mean velocity. For yet lower (sub picolitres) flow rates the carrier fluid mean velocity can be reduced yet further. The flow rates between reagent compartments, \dot{Q}, scales with the carrier fluid mean velocity, V, as follows:

\dot{Q}∝V^{1.57}

Another parameter that can be varied for achieving a desired flow rate is the tube diameter D. Provided the capillary number and fluids remain same the flow rates between reagent compartments, \dot{Q}, scales with the tube diameter, D, as follows:

\dot{Q}∝D²

By suitable parameter selection femtolitre flow rates and lower can be selected.

The film thickness of the fluidic pathways may be estimated using the assumptions that μ_{separating}>>μ_{reagent} (where μ is dynamic viscosity) and therefore the separating compartment behaves as a solid plug and hence the theory of M. E. Charles (Can. J. Chem. Eng. 41, 46 1963) is applicable providing a range of film thicknesses from ˜1-20 μm for the range of flow rate measurements presented in FIG. 16. It is understood however that film thickness down to ˜40 nm have also been measured. For a lower bound estimate of the film thickness the separating compartment may be assumed inviscid, which results in a film thickness of half the solid plug values as estimated above.

By controlling the mean flow rate within the tube the size of the fluid pathways connecting adjacent reagent compartments can be selected. The mean flow rate within the tube can be controlled using either mechanical means or alternatively using gravity feed systems. Similarly, for particle size separation the film thickness can be controlled to a high degree of accuracy by an appropriate selection of separating compartments such that the film thickness between the separating compartments and the carrier fluid is suitable for particle size filtering.

In another variant of the three phase systems for mass transfer described above, two or more reagent compartments that are initially separate may be merged at a specific time. The merging can for example be achieved by way of a blocking compartment, in a similar manner as that described earlier with reference to FIG. 7.

In a variant of a three phase system for mass transfer, described with reference to FIG. 13 above, electrodes (not shown) may be introduced to the reagent compartments to enable electrophoresis/size or charge separation to be achieved through the film regions in analogy with capillary based electrophoresis. An analogous adaptation for electrophoresis in the two phase systems for mass transfer (such as described with reference to FIGS. 13 and 14) may be made, with the electrodes introduced in the carrier fluid. The electrodes may be attached to the tube walls, and the flow in the tube may be interrupted while electrophoresis takes place. The flow in the tube may also be maintained during electrophoresis, in order to support or enhance the electrophoretic separation.

### Ordered Arrangements of Monolayers and Bilayers

FIG. 24 shows water-based reagent compartments 1, 2 . . . 6 divided by a lipid bilayer (i.e. a water-insoluble organic compound film two molecules thick). Around the reagent compartments themselves the film is one molecule thick, forming a lipid monolayer. Specifically, FIG. 24Ai shows six water-based reagent compartments 1, 2 . . . 6, with the single layer film visible on the expanded image. A larger oil separating compartment has subsumed the reagent compartments 3, 4. In FIG. 24Aii a reagent compartment 1 is prevented from travelling with any greater velocity than the oil:reagent interface. However the remaining five compartments 2, 3 . . . 6 do travel at a greater velocity, and so group together. The lipid monolayer (‘thin film’) surrounding the reagent compartments prevents them from merging, and the expanded image shows the formation of a bilayer from the forced physical contact between the two monolayers. FIG. 24Aiii shows a photograph of the array of compartments.

FIG. 24B shows the formation of the minute openings between the water-based compartments. Through the introduction of a bacterial toxin, nano-scale pores can form, allowing the passage of aqueous solutions through the bilayer. The formation of such bilayers can be performed using reagent compartments subsumed within a larger oil separating compartment, provided an amphiphile has been introduced into the oil thereby forming a monolayer around each reagent compartment. The flow must then lead to the reagent compartment abutting, wherein the bilayers form at the points of contact, as shown in FIG. 24A. The formation of the pores increases the permeability of the bilayer, as shown in FIG. 24B, and FIG. 24C shows the preparation of ordered arrangements of monolayer coated reagent compartments using tubes of differing widths, with the bilayers forming where the compartments abut.

More specifically, FIG. 24Bi shows the formation of bilayers following the physical contact between droplets 1 and 2. The formation of these bilayers may lead to the formation of nano-sized openings between the two compartments 1, 2, allowing for the transfer of content as represented by the arrow. FIG. 24Bii shows the coming together of compartments 1, 2. FIGS. 24Biii and 24Biv show the results 1000 minutes after a dye being added. If certain bacterial toxins are added, the dye will enter compartment 1, as shown.

FIG. 24C represents the compartments in 3D. FIGS. 24Ci and 24Cii show the combination of an amphiphile with a larger oil separating compartment, subsuming a water reagent compartment in the process of travelling from a first to a second tube. FIGS. 24Ciii and 24Cviii represent water-based reagent compartments immersed within an oil separating compartment set within a broader tube. Specifically, the square brackets in FIG. 24Cvii capture a recurring pattern, and FIG. 24Cviii shows how lessening the volume of oil forms more densely packed water compartments, with bilayers forming between each of the central six reagent compartments and four other reagent compartments.

Implementation of this Technology in the Field of Biomedicine

FIG. 25 shows how crystals can be obtained, by providing suitable conditions for crystal growth and allowing the screening of numerous different precipitant concentrations and proteins to take place. It is possible for protein to undergo serial dilutions using a series of water-based reagent compartments forming a ‘train’. As represented in FIG. 25i, the first reagent compartment L in the train contains an enzyme, with the remaining five compartments 2, 3 . . . 6 containing a precipitant. An oil separating compartment encloses the reagent compartments. Advection is generated, transporting protein molecules contained in the reagent compartments back through the channels via the film that encompasses each reagent compartment in the separating compartment, thereby forming serial dilutions. Once the series of compartments is stopped, if appropriate conditions are met within any of the compartments, crystals are formed within those compartments, as represented in FIG. 25ii.

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

1-77. (canceled)

78. A method of controlling interactions between fluid compartments in a fluid flow, comprising:
providing a first phase within a fluid conduit;
enclosing within the first phase a separating compartment of a second phase that is immiscible with the first phase;
providing at least one reagent compartment of a third phase that is immiscible with the second phase; and
arranging the compartments such that at least one of the separating compartment and the at least one reagent compartment has a length that is equal to or greater than the conduit diameter.

79. The method according to claim 78, further comprising arranging the compartments such that a thin film of the first phase is formed between the fluid conduit and both the separating compartment and the at least one reagent compartment.

80. The method according to claim 78, further comprising arranging the compartments such that a thin film of the second phase is formed between the at least one reagent compartment and the first phase.

81. The method according to claim 78, further comprising arranging the compartments such that the separating compartment and the at least one reagent compartment have different speeds of travel in the fluid flow.

82. The method according to claim 81, further comprising arranging the compartments with predetermined spacings relative to one another in the direction of flow in the fluid conduit such that after a predetermined period of flow of the compartments the separating compartment confines the at least one reagent compartment to travel at the same speed in the flow.

83. The method according to claim 82, further comprising arranging the compartments such that after a further predetermined period of flow of the compartments a further reagent compartment catches up with the confined reagent compartment due to travel at different speeds in the flow and interacts with the confined reagent compartment.

84. The method according to claim 78, wherein each reagent compartment has a different composition.

85. The method according to claim 78, wherein the reagent compartments have properties such that when the reagent compartments are in contact with one another they merge and mixing of the different reagent compartments occurs, or alternatively wherein the reagent compartments have properties such that when reagent compartments are in contact with one another they do not merge and diffusion between the different reagent compartments occurs.

86. The method according to claim 78, further comprising arranging the or each reagent compartment such that the first phase directly encloses the or each reagent compartment, or alternatively such that the separating compartment directly encloses the or each reagent compartment.

87. The method according to claim 78, further comprising selecting the properties of the three phases so that the surface tensions between the three phases are such that on contact between them, the first phase encloses the second phase, and the second phase encloses the third phase.

88. The method according to claim 78, further comprising: providing at least two separating compartments; enclosing within the first phase a super-separating compartment of a fourth phase that is immiscible with the first phase and immiscible with the second phase, and arranging the compartments with predetermined spacings relative to one another in direction of flow in the fluid conduit such that after a predetermined period of flow of the compartments the super-separating compartment confines at least one of the separating compartments.

89. The method according to claim 78, further comprising: arranging within the separating compartment an indexing compartment of a further phase that is immiscible with the second phase and selecting the properties of the second, third and further phases so that the surface tensions between the three phases are such that on contact between them the second phase encloses the further phase, and the third phase and the further phase do not enclose one another.

90. The method according to claim 89, further comprising arranging one or more indexing compartments between reagent compartments such that merging of reagent compartments is prevented, and/or wherein each separating compartment comprises an indexing compartment that has specific identifying properties for that separating compartment.

91. The method according to claim 78, further comprising flowing the compartments and then reversing the flow direction such that reagent compartments not confined by the separating compartment return to a predetermined spaced arrangement and/or such that a portion of the separating compartment breaks away.

92. The method according to claim 78, further comprising using magnetic particles to transport media within and/or between reagent compartments during fluid flow, wherein the magnetic particles are held in a fixed position by a magnetic field while the reagent compartments flow past and/or wherein a magnetic field is used to move the magnetic particles within and/or between reagent compartments.

93. The method according to claim 92, further comprising transporting the magnetic particles between reagent compartments through the separating compartment and/or between reagent compartments through the first phase and/or between reagent compartments via a thin film that fluidly connects the reagent compartments.

94. The method according to claim 78, further comprising:
selecting the properties of the second phase and/or the third phase so that at a predetermined flow rate instabilities occur at an interface between the second phase and the third phase, causing small emulsion compartments of the reagent compartment to be shed into the separating compartment.

95. The method according to claim 78, further comprising aspiration of the different phases into a channel in a predetermined sequence to create the arrangement of compartments with predetermined spacings.

96. A method of controlling interactions between portions of a fluid in flow comprising:
providing a fluid having a first phase within a fluid conduit;
enclosing within the first phase a separating compartment of a second phase that is immiscible with the first phase; and
arranging the first phase such that it has different properties upstream and downstream of the separating compartment.

97. Apparatus for controlling interactions between fluid compartments in a fluid flow, comprising:
means for providing a first phase within a fluid conduit;
means for enclosing within the first phase a separating compartment of a second phase that is immiscible with the first phase;
means for providing at least one reagent compartment of a third phase that is immiscible with the second phase; and
means for arranging the compartments such that at least one of the separating compartment and the at least one reagent compartment has a length equal to or greater than the fluid conduit diameter.
